(19) United States
(12) Patent Application Publication
(10) Pub. No.: US 2026/0348520 A1
(43) Pub. Date: Nov. 5, 2026

(54) MOUNT BRACKET

(71) Applicant: HANWHA VISION CO., LTD., Seongnam-si (KR)

(72) Inventors: Eun Soo Choi, Seongnam-si (KR); Ji Seok Kim, Seongnam-si (KR)

(73) Assignee: HANWHA VISION CO., LTD., Seongnam-si (KR)

(21) Appl. No.: 19/659,505

(22) Filed: Apr. 27, 2026

(30) Foreign Application Priority Data
Apr. 30, 2025 (KR) 10-2025-0057762

(51) Int. Cl. F16M 13/02; F16M 11/08; F16M 11/20

(52) U.S. Cl. CPC F16M 13/025; F16M 11/08; F16M 11/2014

(57) ABSTRACT

A mount bracket may include: a shaft; a first bracket including: a first connecting portion configured to be connected to the shaft; and a first wing portion extending from the first connecting portion; a second bracket including: a second connecting portion configured to be connected to the shaft; and a second wing portion extending from the second connecting portion; a coupler configured to be connected to the shaft; and a fixing portion configured to be connected to the first connecting portion or the second connecting portion, the fixing portion further configured to prevent rotation of the shaft, wherein the first bracket and the second bracket are configured to be rotatably connected to the shaft such that an angle between the first wing portion and the second wing portion is adjustable.

### CROSS-REFERENCE TO RELATED APPLICATION

This application is based on and claims priority under 35 U.S.C. §119 to Korean Patent Application No. 10-2025-0057762, filed on Apr. 30, 2025, in the Ministry of Intellectual Property, Republic of Korea, the disclosure of which is incorporated herein in its entirety by reference.

### BACKGROUND

### 1. Field

Some embodiments of the present disclosure relate to a mount bracket.

### 2. Description of Related Art

Mount brackets may be used to install various devices, such as cameras, lighting devices, and speakers, on corners, walls, ceilings, or other structures. However, in the related art, since mount brackets have a fixed angle, there is inconvenience in that a new mount bracket has to be installed when a corner angle is different from the fixed angle.

### SUMMARY

According to some embodiments of the present disclosure, a mount bracket that is capable of adapting to an angle and/or a shape of a structure on which the mount bracket is to be installed may be provided.

According to some embodiments of the present disclosure, a mount bracket may include: a shaft; a first bracket including: at least one first connecting portion configured to be connected to the shaft; and a first wing portion extending from the at least one first connecting portion; a second bracket including: at least one second connecting portion configured to be connected to the shaft; and a second wing portion extending from the at least one second connecting portion; a coupler configured to be connected to the shaft; and at least one fixing portion configured to be connected to the at least one first connecting portion or the at least one second connecting portion, the at least one fixing portion further configured to prevent rotation of the shaft, wherein the first bracket and the second bracket are configured to be rotatably connected to the shaft such that an angle between the first wing portion and the second wing portion is adjustable.

According to some embodiments of the present disclosure, the at least one fixing portion is further configured to fix the first bracket or the second bracket to the shaft.

According to some embodiments of the present disclosure, the at least one fixing portion includes at least one cap that is configured to be mounted on the at least one first connecting portion or the at least one second connecting portion, the at least one cap configured to press the shaft in an axial direction of the shaft.

According to some embodiments of the present disclosure, the at least one fixing portion includes: a first cap configured to screw-couple to an inner surface of a first connecting portion or a second connecting portion located at an upper position in an axial direction of the shaft among the at least one first connecting portion or the at least one second connecting portion, the first cap configured to contact an upper end of the shaft; and a second cap configured to screw-couple to an inner surface of a first connecting portion or a second connecting portion located at a lower position in the axial direction among the at least one first connecting portion or the at least one second connecting portion, the second cap configured to contact a lower end of the shaft, and wherein the first cap and the second cap are configured to fix the shaft by pressing the upper end of the shaft and the lower end of the shaft, respectively.

According to some embodiments of the present disclosure, the at least one cap includes a fixing protrusion, the fixing protrusion configured to contact an end of the shaft, and wherein the shaft includes a shaft protrusion on a surface of the shaft, the shaft protrusion configured to contact the fixing protrusion.

According to some embodiments of the present disclosure, the at least one first connecting portion or the at least one second connecting portion includes an end hole, and wherein the mount bracket further includes a set screw that is configured to be inserted into the end hole and contact an outer surface of the shaft.

According to some embodiments of the present disclosure, the shaft includes a serration that is configured to contact the set screw.

According to some embodiments of the present disclosure, in a state where the at least one fixing portion is separated from the at least one first connecting portion or the at least one second connecting portion, the coupler is configured to rotate together with the shaft.

According to some embodiments of the present disclosure, the mount bracket further includes a shaft locker that is configured to be inserted into the shaft through the coupler, wherein the at least one fixing portion is configured to be connected to the at least one first connecting portion or the at least one second connecting portion, and wherein the shaft locker is configured to be connected to the coupler and prevent the rotation of the shaft.

According to some embodiments of the present disclosure, the at least one first connecting portion includes two first connecting portions, the two first connecting portions being spaced apart from each other and configured to be respectively connected to an upper portion of the shaft and a lower portion of the shaft in an axial direction of the shaft, wherein the at least one second connecting portion includes two second connecting portions, the two second connecting portions configured to be between the two first connecting portions in the axial direction while the two second connecting portions are connected to the shaft, and wherein the at least one fixing portion is configured to be mounted on each of the two first connecting portions.

According to some embodiments of the present disclosure, the at least one fixing portion includes a first cap, the first cap configured to be connected to the at least one first connecting portion or the at least one second connecting portion, and wherein the first cap includes: a first inner hole that corresponds to a first shaft hole, the first shaft hole being in an upper end of the shaft; a first outer hole that corresponds to a first outer fastening hole, the first outer fastening hole being in an end of the at least one first connecting portion or the at least one second connecting portion; a first inner screw that is configured to be fastened into the first shaft hole through the first inner hole; and a first outer screw that is configured to be fastened into the first outer fastening hole through the first outer hole.

According to some embodiments of the present disclosure, the first outer hole includes an elongated hole shape that extends in a circumferential direction of the first cap, wherein, in a state where threads of the first outer screw are not engaged with the first outer fastening hole, the first outer screw is movable along the first outer hole in the circumferential direction, and the first bracket is configured to be rotatable about the shaft.

According to some embodiments of the present disclosure, the first outer screw includes a spring, wherein a portion of the first outer screw is movable along the first outer hole while being pre-engaged with the first outer fastening hole, and wherein, in a case where the first outer screw is pressed, the first cap is configured to be fixed to the at least one first connecting portion by threads of the first outer screw being engaged with the first outer fastening hole.

According to some embodiments of the present disclosure, the first cap is configured to be mounted on a first connecting portion or a second connecting portion, which is connected to an upper portion of the shaft, among the at least one first connecting portion or the at least one second connecting portion, wherein the at least one fixing portion further includes a second cap that is configured to be mounted on a first connecting portion or a second connecting portion, which is connected to a lower portion of the shaft, among the at least one first connecting portion or the at least one second connecting portion, and wherein the second cap is configured to be screw-coupled to an inner surface of the first connecting portion or the second connecting portion, which is connected to the lower portion of the shaft, and contact a lower end of the shaft.

According to some embodiments of the present disclosure, the first cap is configured to be mounted on a first connecting portion or a second connecting portion, which is connected to an upper portion of the shaft, among the at least one first connecting portion or the at least one second connecting portion, wherein the at least one fixing portion further includes a second cap that is configured to be mounted on a first connecting portion or a second connecting portion, which is connected to a lower portion of the shaft, among the at least one first connecting portion or the at least one second connecting portion, wherein the second cap includes: a second inner hole that corresponds to a second shaft hole, the second shaft hole being in a lower end of the shaft; a second outer hole corresponding to an outer fastening hole, the outer fastening hole being in an end of the first connecting portion or the second connecting portion connected to the lower portion of the shaft; a second inner screw that is configured to be fastened into the second shaft hole through the second inner hole; and a second outer screw that is configured to be fastened into the outer fastening hole through the second outer hole.

According to some embodiments of the present disclosure, the at least one fixing portion includes a first cap that is configured to be mounted on a first connecting portion or a second connecting portion, which is located at an upper portion of the shaft in the axial direction, among the at least one first connecting portion or the at least one second connecting portion, wherein the first cap includes: an anchor configured to be inserted into the shaft and the first connecting portion or the second connecting portion; an anchor spring in the anchor; an outer hole corresponding to an outer fastening hole, the outer fastening hole being in an end of the first connecting portion or the second connecting portion; and an outer screw configured to be fastened into the outer fastening hole through the outer hole, and wherein the anchor is configured to, by pressing of the anchor spring, press an end of the shaft in the axial direction.

According to some embodiments of the present disclosure, the anchor spring is configured to, in an unpressed state, separate the anchor from an upper end of the shaft.

According to some embodiments of the present disclosure, in a case where the anchor spring is in an unpressed state, the outer screw is configured to be pre-engaged with the outer fastening hole, and wherein, in a case where the anchor spring is in a pressed state, the anchor contacts an upper end of the shaft and the outer screw is configured to be fastened into the outer fastening hole.

According to some embodiments of the present disclosure, the anchor includes a lower protrusion, wherein the shaft includes a stopper on an inner surface of the shaft, wherein a lower end of the anchor spring is configured to contact an upper surface of the stopper, and wherein the stopper is configured to restrict a rising height of the lower protrusion.

According to some embodiments of the present disclosure, a mount bracket may include: a shaft; a first bracket including: two first connecting portions configured to be connected to an upper portion of the shaft and a lower portion of the shaft in an axial direction of the shaft, respectively; and a first wing portion extending from the two first connecting portions; a second bracket including: two second connecting portions configured to be between the two first connecting portions while the two second connecting portions are connected to the shaft; and a second wing portion extending from the two second connecting portions; a coupler configured to be between the two second connecting portions, wherein the shaft is configured to be inserted into the coupler and the coupler is configured to mount an external device; a first cap configured to be mounted on an uppermost first connecting portion among the two first connecting portions, the first cap fixing the shaft to the uppermost first connecting portion; and a second cap configured to be mounted on a lowermost first connecting portion among the two first connecting portions, the second cap fixing the shaft to the lowermost first connecting portion, wherein the first bracket and the second bracket are configured to be rotatable about the shaft, such that the first wing portion and the second wing portion are arranged at an angle corresponding to a shape of an installation structure, and wherein the first cap and the second cap are configured to fix the two first connecting portions to the shaft to prevent rotation of the first bracket and the shaft.

However, problems solved by embodiments of the present disclosure are not limited to the above-described problems, and other unmentioned problems solved by embodiments of the present disclosure may be clearly understood by those skilled in the art from the description of the present disclosure set forth below.

Additional aspects will be set forth in part in the description which follows and, in part, will be apparent from the description, or may be learned by practice of the example embodiments of the present disclosure.

### BRIEF DESCRIPTION OF DRAWINGS

The following drawings illustrate non-limiting example embodiments of the present disclosure and serve to provide an understanding of aspects of the present disclosure together with the description of the present disclosure provided below.

The above and other aspects, features, and advantages of certain embodiments of the present disclosure will be more apparent from the following description taken in conjunction with the accompanying drawings, in which:

FIG. 1 illustrates a perspective view of a mount bracket according to embodiments;

FIG. 2 illustrates an exploded perspective view of the mount bracket of FIG. 1;

FIG. 3 illustrates a cross-sectional view taken along a line A-A’ of FIG. 1;

FIG. 4 illustrates a cross-sectional view taken along a line B-B’ of FIG. 1;

FIG. 5 illustrates a shaft, a second cap, and a set screw according to embodiments;

FIGS. 6A, 6B, and 6C illustrate operations of installing a mount bracket according to embodiments;

FIGS. 7A, 7B, 7C, 7D, 7E, 7F, and 7G illustrate various states in which a mount bracket according to embodiments is installed on different installation structures;

FIG. 8 illustrates a perspective view of a mount bracket according to embodiments;

FIG. 9 illustrates an exploded perspective view of the mount bracket of FIG. 8;

FIG. 10 illustrates a first bracket, a shaft, and a first cap according to embodiments;

FIGS. 11A, 11B, 11C, and 11D illustrate operations of installing a mount bracket according to embodiments;

FIG. 12 illustrates a perspective view of a mount bracket according to embodiments;

FIG. 13 illustrates an exploded perspective view of the mount bracket of FIG. 12;

FIG. 14 illustrates a first bracket, a shaft, and a first cap according to embodiments;

FIG. 15 illustrates a first bracket, a shaft, and a second cap according to embodiments;

FIGS. 16A, 16B, 16C, 16D, and 16E illustrate operations of installing a mount bracket according to embodiments;

FIG. 17 illustrates a perspective view of a mount bracket according to embodiments;

FIG. 18 illustrates an exploded perspective view of the mount bracket of FIG. 17;

FIGS. 19A and 19B illustrate states in which a mount bracket according to embodiments is fixed; and

FIGS. 20A, 20B, and 20C illustrate operations of installing a mount bracket according to embodiments.

### DETAILED DESCRIPTION

Hereinafter, non-limiting example embodiments of the present disclosure will be described in detail with reference to the accompanying drawings. However, the present disclosure is not limited to the example embodiments described below, and it will be apparent to those of ordinary skill in the art that various modifications, alterations, substitutions, and additions may be made without departing from the spirit and scope of the present disclosure.

Throughout this specification, like reference numerals generally designate like or functionally similar elements. In the drawings, the size, length, thickness, or spacing of each element may be exaggerated or omitted for clarity of illustration. Accordingly, the shapes and proportions shown in the drawings may be merely illustrative and may vary depending on various changes in actual implementation.

In describing the present disclosure, detailed descriptions of technologies, configurations, and operating principles that are widely known in the relevant field or readily understood by those of ordinary skill in the art may be omitted or briefly mentioned so as not to unnecessarily obscure the subject matter of the present disclosure. Such known technologies, configurations, and principles may be used in combination with embodiments of the present disclosure, and those of ordinary skill in the art may readily derive various implementations by combining them with the contents described herein.

Unless expressly stated otherwise, the terms used in this specification have their ordinary meanings as understood in the relevant technical field. Singular forms may include plural forms depending on context, and terms such as “includes” (or “comprises”) or “may include” (or “may comprise”) are used in a non-exclusive sense that does not preclude the presence or addition of elements other than those listed. In the specification, the term “and/or” generally may include all combinations of one or more relevant listed items. For example, an expression such as “A and/or B” may include A, B, or both A and B. Although the terms “first,” “second,” “third,” and the like may be used in the specification to describe various elements, components, regions, layers, and/or cross-sections, such elements, components, regions, layers, and/or cross-sections may not be limited by these terms.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

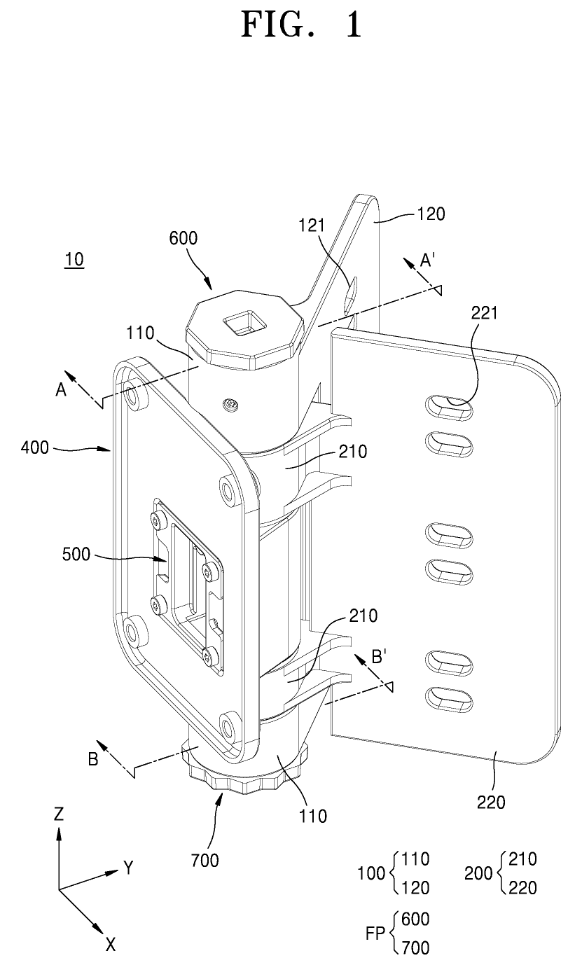

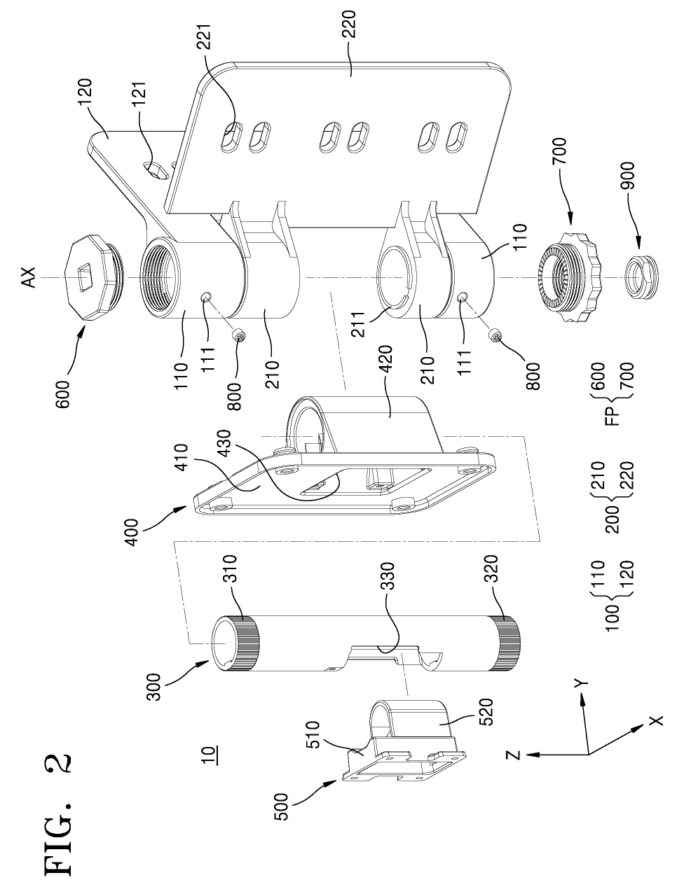

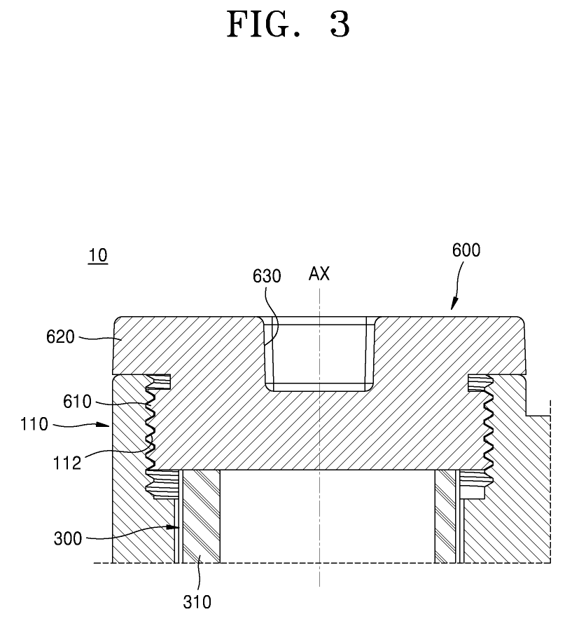

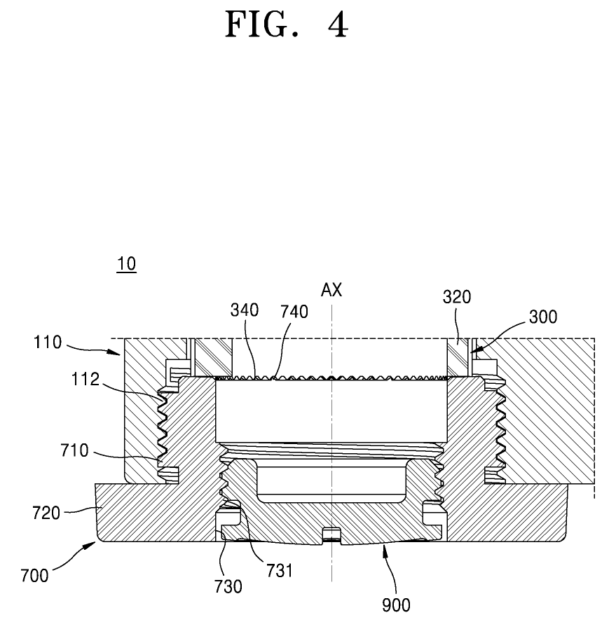

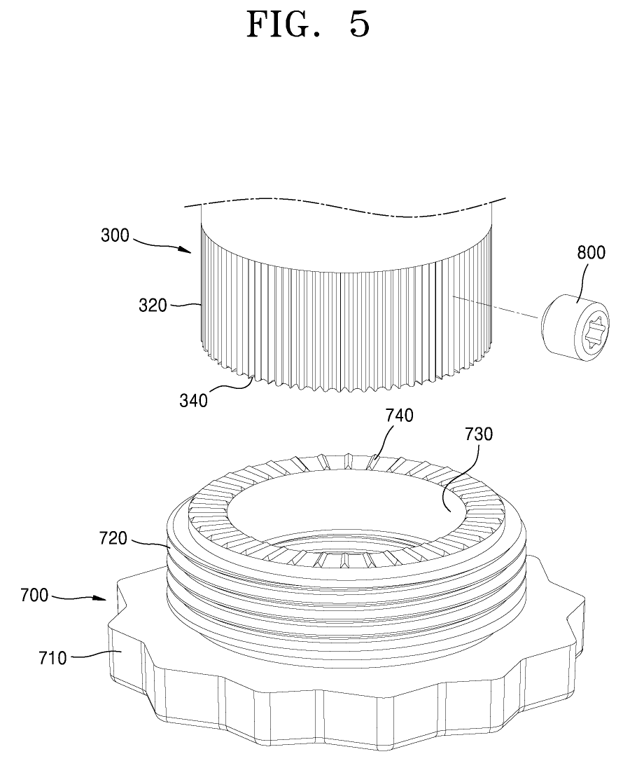

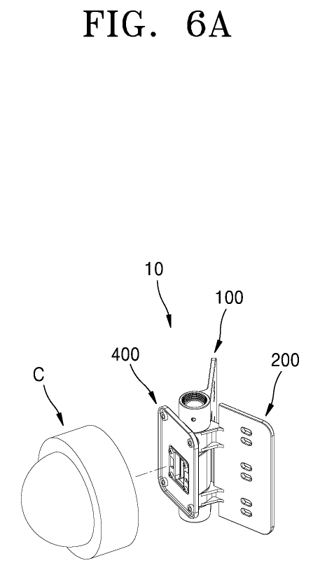

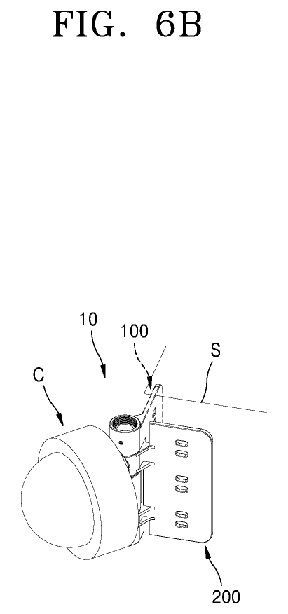

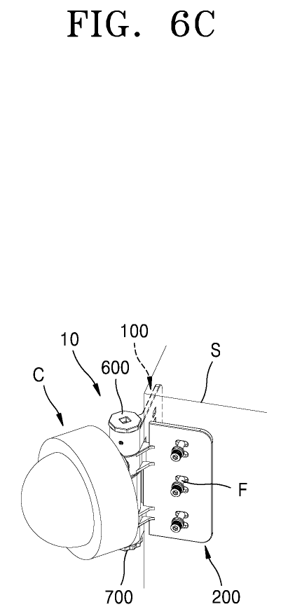

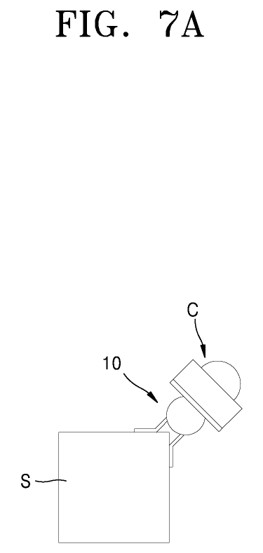

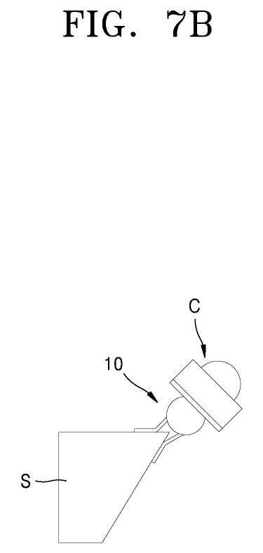

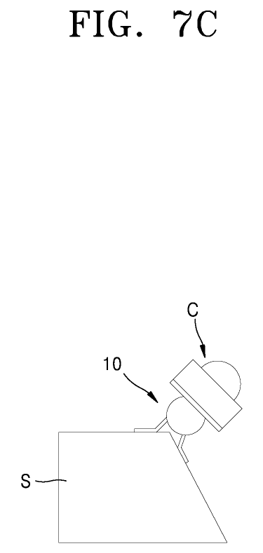

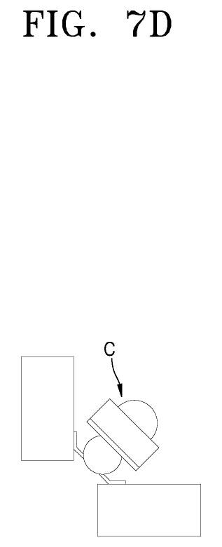

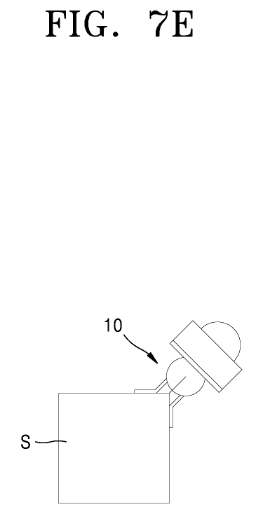

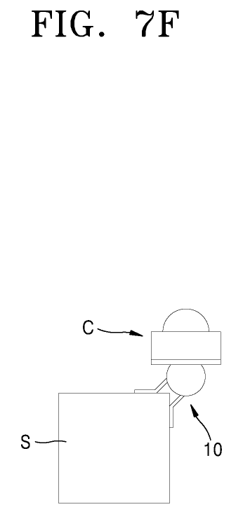

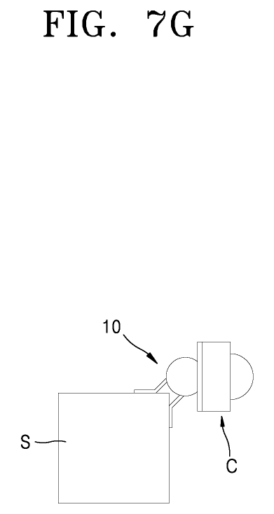

FIG. 1 illustrates a perspective view of a mount bracket 10 according to embodiments, FIG. 2 illustrates an exploded perspective view of the mount bracket 10 of FIGS. 1, FIG. 3 illustrates a cross-sectional view taken along a line A-A’ of FIGS. 1, FIG. 4 illustrates a cross-sectional view taken along a line B-B’ of FIGS. 1, FIG.5 illustrates a shaft 300, a second cap 700, and a set screw 800 according to embodiments, FIGS. 6A, 6B, and 6C illustrate operations of installing the mount bracket 10 according to embodiments, and FIGS. 7A, 7B, 7C, 7D, 7E, 7F, and 7G illustrate various states in which the mount bracket 10 according to embodiments is installed on different installation structures S.

The mount bracket 10 according to embodiments may be a device for installing a camera, lighting, or various electronic devices (hereinafter also referred to as “external devices”) on another structure (hereinafter also referred to as “installation structures”) such as a wall, ceiling, or frame. The mount bracket 10 may be angle-adjustable to be adaptable to installation structures having various angles and shapes. For example, the mount bracket 10 may, until being fixed to the installation structure, adjust an angle of a portion to be installed on the installation structure and a direction in which an external device is oriented.

The mount bracket 10 according to embodiments may include the shaft 300, a first bracket 100 including one or more first connecting portions 110 connected to the shaft 300 and a first wing portion 120 extending from the one or more first connecting portions 110, a second bracket 200 including one or more second connecting portions 210 connected to the shaft 300 and a second wing portion 220 extending from the one or more second connecting portions 210, a coupler 400 connected to the shaft 300, and one or more fixing portions coupled to the one or more first connecting portions 110 and/or the one or more second connecting portions 210 and configured to prevent rotation of the shaft 300. The first bracket 100 and the second bracket 200 may be rotatably connected to the shaft 300 such that an angle between the first wing portion 120 and the second wing portion 220 is adjustable.

The mount bracket 10 according to embodiments may include the shaft 300, the first bracket 100 including two first connecting portions 110 connected, in an axial direction, to an upper portion and a lower portion, respectively, of the shaft 300 and the first wing portion 120 extending from the two first connecting portions 110, the second bracket 200 including two second connecting portions 210 disposed between the two first connecting portions 110 and connected to the shaft 300 and the second wing portion 220 extending from the two second connecting portions 210, the coupler 400 disposed between the two second connecting portions 210, into which the shaft 300 is inserted, and on which an external device C (refer to FIGS. 6A-6C) is mounted, a first cap 600 mounted on an upper one of the two first connecting portions 110 and fixing the shaft 300 to the upper one of the two first connecting portions 110, and a second cap 700 mounted on a lower one of the two first connecting portions 110 and fixing the shaft 300 to the lower one of the two first connecting portions 110. The first bracket 100 and the second bracket 200 may be rotatable about the shaft 300 such that the first wing portion 120 and the second wing portion 220 are arranged at an angle corresponding to a shape of the installation structure S, as shown in FIGS. 6A-7G. The first cap 600 and the second cap 700 may be configured to fix the first connecting portions 110 to the shaft 300 to prevent rotation of the first bracket 100 and the shaft 300.

The mount bracket 10 according to embodiments may include the first bracket 100, the second bracket 200, the shaft 300, the coupler 400, a shaft locker 500, fixing portions FP, and at least one set screw 800.

The first bracket 100 may be mounted on an installation structure and may be connected to the shaft 300. As the first bracket 100 and the second bracket 200 connected to the shaft 300 rotate, the angle between the first bracket 100 and the second bracket 200 may be adjusted, and the mount bracket 10 may adapt to a shape or a size of the installation structure. The first bracket 100 may be rotatably connected to the shaft 300 and may provide a mounting region that may be mounted on the installation structure. The first bracket 100 may, until fixed to the shaft 300 by the first cap 600, rotate freely.

As shown in FIGS. 1 and 2, the first bracket 100 may include the first connecting portions 110 and the first wing portion 120.

The first connecting portion 110 may be a part connected to the shaft 300, and the one or more first connecting portions 110 may be included. The first connecting portion 110 may have a ring shape that surrounds the outer surface of the shaft 300. For example, as shown in FIGS. 1 and 2, the first bracket 100 may include the two first connecting portions 110 (e.g., an upper first connecting portion and a lower first connecting portion)). The two first connecting portions 110 may surround a first end and a second end of the shaft 300, respectively, in the longitudinal direction of the shaft 300 or in a Z-axis direction or an axial direction of FIG. 1. The first connecting portion 110 may be rotatable with respect to the shaft 300 about a central axis AX.

The first connecting portion 110 may include an end hole 111.

One or more end holes 111 may be formed in the first connecting portion 110, and a set screw 800 may be engaged therein. An end of the set screw 800 inserted into the end hole 111 may be in contact with the outer surface of the shaft 300 to prevent the first connecting portion 110 from rotating about the shaft 300. For example, as shown in FIG. 2, one end hole 111 may be formed for each first connecting portion 110. Each end hole 111 may be formed at a position corresponding to a first serration 310 and a second serration 320 of the shaft 300.

The first connecting portion 110 may include a screw thread 112. As shown in FIGS. 3 and 4, the screw thread 112 is formed on an inner side of each first connecting portion 110, and the screw thread 112 may be coupled with the first cap 600 and the second cap 700. The first cap 600 and the second cap 700 may be coupled to respective ones of the first connecting portions 110 through respective screw threads 112, and, while being coupled, ends of the first cap 600 and the second cap 700 may respectively press against opposite ends of the shaft 300 to prevent the shaft 300 from rotating.

The first wing portion 120 may be connected to the first connecting portion 110 and may provide a mounting region that may be mounted on the installation structure. For example, as shown in FIGS. 1 and 2, the first wing portion 120, having an inner edge connected to the two first connecting portions 110, may have a rectangular shape with a long side in the axial direction. The shape and size of the first wing portion 120 are not particularly limited and may vary depending on the size and the shape of the installation structure, a load and a size of external devices such as cameras, and a load to be borne by the first wing portion 120. For example, the first wing portion 120 may have a rectangular shape having a long side in a horizontal direction perpendicular to the axial direction, or may have a shape such as a semicircle, a semi-ellipse, or a triangle.

When the first connecting portion 110 rotates, the first wing portion 120 may also rotate about the shaft 300. The installation structure is positioned in a space between the first wing portion 120 and the second wing portion 220, and inner surfaces of the first wing portion 120 and the second wing portion 220 facing each other may be mounted on the installation structure.

The first wing portion 120 may include a first mounting hole 121.

The first mounting hole 121 may be formed in the first wing portion 120 and may be fastened with a fastening member such that the first wing portion 120 is fixed to the installation structure. The first wing portion 120 may include a plurality of first mounting holes 121. When angle adjustment of the first bracket 100 is completed, the fastening member may be fastened into the plurality of first mounting holes 121.

The second bracket 200 may be mounted on the installation structure and may be connected to the shaft 300. The second bracket 200 may be rotatably connected to the shaft 300 and may provide a mounting region that may be mounted on the installation structure. Regardless of whether the first bracket 100 and the shaft 300 are fixed to each other, the second bracket 200 may always rotate about the shaft 300.

As shown in FIGS. 1 and 2, the second bracket 200 may include the second connecting portion 210 and the second wing portion 220.

The second connecting portion 210 is a part connected to the shaft 300, and the one or more second connecting portions 210 may be included. The second connecting portion 210 may have a ring shape that wraps around the outer surface of the shaft 300. For example, as shown in FIGS. 1 and 2, the second bracket 200 may include the two second connecting portions 210, one upper and the other lower. The two second connecting portions 210 may wrap around a first end and a second end, respectively, in the longitudinal direction of the shaft 300 (or in the Z-axis direction or an axial direction of FIG. 1). The second connecting portion 210 may be rotatable with respect to the shaft 300 about the central axis AX. As shown in FIG. 2, the two second connecting portions 210 may be respectively located between an upper one of the first connecting portions 110 and a first sleeve 420 and between a lower one of the first connecting portions 110 and the first sleeve 420. As shown in FIG. 2, the two second connecting portions 210 may be respectively located between an upper one of the first connecting portions 110 and a first sleeve 420 and between a lower one of the first connecting portions 110 and the first sleeve 420.

The second connecting portion 210 may include, at an end thereof contacting the first connecting portion 110 or the first sleeve 420, a friction-preventing member such as a washer or a bearing or a sealing member such as an O-ring.

The second connecting portion 210 may include one or more end protrusions 211. The end protrusions 211 may be formed at ends, facing each other, of the second connecting portions 210, respectively, in the axial direction, and may be respectively inserted into grooves formed at opposite ends of the first sleeve 420. The end protrusions 211 may support the first connecting portion 110, the second connecting portion 210, and the first sleeve 420 to prevent disengagement in a radial direction while allowing coaxial rotation of the first connecting portion 110, the second connecting portion 210, and the first sleeve 420 around the axial direction. Alternatively, grooves may be formed at opposite ends of each of the second connecting portions 210 and protrusions corresponding to the grooves may be formed at ends, facing each other, of the first connecting portions 110 and the first sleeve 420, respectively.

Although FIGS. 1 and 2 show that the two second connecting portions 210 are located between the first connecting portions 110 in the axial direction, the two second connecting portions 210 may be respectively located outside the first connecting portions 110 in the axial direction. In this case, the first cap 600 and the second cap 700 may be mounted on the second connecting portion 210, and the end hole 111 may also be formed in the second connecting portion 210. The first bracket 100 may freely rotate about the shaft 300.

The second wing portion 220 may be connected to the second connecting portions 210 and may provide a mounting region that may be mounted on the installation structure. For example, as shown in FIGS. 1 and 2, the second wing portion 220, having an inner edge connected to the two second connecting portions 210, may have a rectangular shape with a long side extending in the axial direction. The shape and size of the second wing portion 220 are not particularly limited, and may be the same as or different from those of the first wing portion 120.

As the second connecting portions 210 rotate, the second wing portion 220 may also rotate about the shaft 300. The angle between the second wing portion 220 and the first wing portion 120 may be limited as the first wing portion 120 and the second wing portion 220 contact each other. For example, as shown in FIG. 1, when the inner edge of the second wing portion 220 comes into contact with the inner surface of the first wing portion 120, the first wing portion 120 and the second wing portion 220 may no longer rotate toward each other. As the first wing portion 120 and the second wing portion 220 function as rotation stoppers by coming into contact with each other, the mount bracket 10 may be more easily installed on the installation structure without either the first wing portion 120 or the second wing portion 220 interfering with the installation structure. A minimum angle between the first wing portion 120 and the second wing portion 220 is not particularly limited and may vary depending on shapes and sizes of the first wing portion 120 and the second wing portion 220, and may be adjusted depending on the shape and the size of the installation structure.

The second wing portion 220 may include at least one second mounting hole 221.

The second mounting hole 221 may be formed in the second wing portion 220 and a fastening member may be fastened in the second mounting hole 221 such that the second wing portion 220 is fixed to the installation structure. The second wing portion 220 may include a plurality of second mounting holes 221. When angle adjustment of the second bracket 200 is completed, a plurality of fastening members may be fastened into the plurality of second mounting holes 221.

The shaft 300 may be connected to the first bracket 100, the second bracket 200, the coupler 400, and the shaft locker 500. The shaft 300 may extend in a height direction of the mount bracket 10 or the Z-axis direction in FIG. 2 and may be coaxial with the central axis AX of the mount bracket 10. The shaft 300 may provide a rotation center for the first bracket 100 and the second bracket 200. As shown in FIG. 2, the shaft 300 may have a cylindrical rod shape and may be inserted into the first connecting portions 110, the second connecting portions 210, and the first sleeve 420. For example, in a state where the first sleeve 420 is positioned between the two second connecting portions 210, the shaft 300 may be inserted into the first connecting portions 110 and may be connected to the two first connecting portions 110, the two second connecting portions 210, and the first sleeve 420.

The shaft 300 may be freely rotatable before being fixed, and by rotation of the coupler 400 and the shaft locker 500 which are connected to the shaft 300, a direction to which an external device is oriented may also be changed. For example, until the first cap 600 and the second cap 700 are coupled to the first connecting portions 110, the shaft 300 may be rotatable independently of the first bracket 100. In this state, the first bracket 100 and the second bracket 200 may rotate about the shaft 300, and the shaft 300 may also rotate. Accordingly, by rotating the coupler 400 and the shaft locker 500 that are connected to the shaft 300, the direction to which the external device connected to the coupler 400 is oriented may be freely changed. When the angle adjustment and the direction adjustment are completed, the shaft 300 and the first bracket 100 may be fixed by connecting (e.g., coupling) the first cap 600 and the second cap 700 to the first connecting portion 110.

The shaft 300 may include the first serration 310, the second serration 320, and a coupling hole 330.

The first serration 310 may be positioned at an upper end of the shaft 300 and may include a plurality of protrusions formed around the outer surface of the shaft 300 at the upper end. For example, as shown in FIG. 2, the first serration 310 may include the plurality of protrusions extending in the axial direction of the shaft 300. The first serration 310 may be inserted inside the first connecting portion 110 located at an upper position among a plurality of first connecting portions 110 and may come into contact with a set screw 800. The first serration 310 increases a frictional force in a region of the shaft 300 in contact with the set screw 800, thereby preventing the shaft 300 from rotating after installation of the mount bracket 10.

The second serration 320 may be positioned at a lower end of the shaft 300 and may include a plurality of protrusions formed around the outer surface of the shaft 300 at the lower end. For example, as shown in FIG. 2, the second serration 320 may include the plurality of protrusions extending in the axial direction of the shaft 300. The second serration 320 may be inserted inside the first connecting portion 110 located at a lower position among the plurality of first connecting portions 110 and may come into contact with another set screw 800. The second serration 320 may increase a frictional force in a region of the shaft 300 in contact with the set screw 800, thereby preventing the shaft 300 from rotating after installation of the mount bracket 10.

The coupling hole 330 may be formed by opening a portion of the shaft 300 and may accommodate the shaft locker 500. For example, as shown in FIG. 2, the coupling hole 330 may be formed in a central portion of the shaft 300 in the axial direction. A second sleeve 520 of the shaft locker 500 may be inserted into the coupling hole 330. After the shaft 300 is inserted into the coupler 400 and the second sleeve 520 is inserted into the coupling hole 330, a coupling plate 510 of the shaft locker 500 may be coupled to a mounting plate 410 of the coupler 400. Accordingly, the shaft 300, the coupler 400, and the shaft locker 500 may be connected to each other.

The coupling hole 330 may have a size and a shape corresponding to a size and a shape of the second sleeve 520 of the shaft locker 500. For example, a width of the coupling hole 330 in a circumferential direction may correspond to (e.g., may be substantially equal to) the size of the second sleeve 520. Accordingly, In a state where the shaft locker 500 is coupled to the coupling hole 330, when the shaft 300 rotates, the coupling hole 330 may be caught on the shaft locker 500. Accordingly, the shaft 300 may not rotate independently but may rotate together with the shaft locker 500 and the coupler 400.

The coupler 400 may be connected to the shaft 300 and may provide a mounting surface on which an external device is mounted. For example, as shown in FIG. 2, the shaft 300 may be inserted into the coupler 400, and the coupler 400 may be positioned between the first bracket 100 and the second bracket 200. The coupler 400 may rotate together with the shaft 300 via the shaft locker 500.

The coupler 400 may include the mounting plate 410, the first sleeve 420, and an opening 430.

The mounting plate 410 may provide a mounting surface on which an external device is mounted. For example, as shown in FIGS. 1 and 2, the mounting plate 410 may have a rectangular shape and may include a plurality of coupling holes which are configured to be connected (e.g., coupled) with the external device. A shape and a size of the mounting plate 410 are not particularly limited and may vary depending on a size and a shape of the external device. The mounting plate 410 may be connected to the shaft 300 via the first sleeve 420, and a direction to which the external device is oriented may be adjusted by rotating the mounting plate 410.

The first sleeve 420 may be positioned at a rear surface of the mounting plate 410 and may have a hollow cylindrical shape surrounding the shaft 300. Opposite ends of the first sleeve 420 in the axial direction may be connected to the upper and lower ones of the second connecting portions 210, respectively. In a state where the first sleeve 420 is positioned between the second connecting portions 210, the shaft 300 may be inserted into the two first connecting portions 110, the two second connecting portions 210, and the first sleeve 420. The first sleeve 420 may be coaxial with the shaft 300.

The opening 430 may be formed in the mounting plate 410 and may communicate with the first sleeve 420. As shown in FIG. 2, the opening 430 may be formed at a central portion of the mounting plate 410, and the shaft locker 500 may be inserted into the opening 430. In a state where the shaft 300 and the coupler 400 are connected (e.g., coupled), the second sleeve 520 may be inserted into the coupling hole 330 through the opening 430, and the coupling plate 510 may be fitted into the opening 430. The opening 430 may include a plurality of coupling holes for fixing the coupling plate 510. By coupling the coupling plate 510 to the opening 430, the shaft 300, the coupler 400, and the shaft locker 500 may rotate integrally.

The shaft locker 500 may allow the shaft 300 not to rotate independently but to rotate together with the shaft locker 500 and the coupler 400. The shaft locker 500 may be inserted into the coupling hole 330 of the shaft 300 and may be connected (e.g., coupled) to the coupler 400. The shaft locker 500 may fix (independent) rotation of the shaft 300 so as not to spin freely.

The shaft locker 500 may include the coupling plate 510 and the second sleeve 520.

The coupling plate 510 may, by connected (e.g., coupling) to the opening 430 of the coupler 400, connect the coupler 400 and the shaft locker 500. The coupling plate 510 may be connected (e.g., coupled) to the opening 430 via at least one fastening member fastened to coupling holes provided in the opening 430.

The second sleeve 520 may be positioned at a rear surface of the coupling plate 510. As shown in FIG. 2, the second sleeve 520 may be inserted inside the shaft 300 through the coupling hole 330. The second sleeve 520 may have a curved shape corresponding to an inner surface of the shaft 300. A curved portion of the second sleeve 520 may contact the inner surface of the shaft 300, and opposite side surfaces of the second sleeve 520 may contact circumferential edges of the coupling hole 330. Accordingly, the second sleeve 520 may be fitted into the coupling hole 330, and when the shaft 300 rotates, surfaces of the shaft 300, defining the coupling hole 330, and the second sleeve 520 may contact each other such that the shaft 300 may not rotate independently.

The rotation of the shaft 300 may be fixed as the fixing portions FP are connected to the first connecting portion 110, and the shaft locker 500 may be fastened into the coupler 400.

The fixing portions FP may fix the first bracket 100 or the second bracket 200 and the shaft 300 such that the first bracket 100 or the second bracket 200 and the shaft 300 do not rotate. After the mount bracket 10 is installed on an installation structure and a direction of an external device is determined, the fixing portions FP may be mounted on the first bracket 100 or the second bracket 200 such that the first bracket 100 or the second bracket 200 may not rotate about the shaft 300. The fixing portions FP may be mounted on the first connecting portion 110 or the second connecting portion 210. Hereinafter, for convenience of description, a case in which the fixing portions FP are mounted on the first connecting portions 110 will be mainly described. The same fixing method may also be applied when the fixing portions FP are mounted on the second connecting portions 210.

The fixing portions FP may include the first cap 600 and the second cap 700.

The first cap 600 may be mounted on the first connecting portion 110 located at an upper position in the axial direction. As shown in FIG. 3, the first cap 600 may be detachable from the first connecting portion 110 and may press the upper end of the shaft 300 downward. Because the second cap 700 presses the lower end of the shaft 300 upward, the first cap 600 and the second cap 700 may prevent rotation of the shaft 300 with respect to the first bracket 100 and the second bracket 200. The first cap 600 may be coaxial with the central axis AX when mounted on the first connecting portion 110.

The first cap 600 may include a first cap thread 610, a first handle 620, and a first inner groove 630.

The first cap thread 610 may be formed on the outer surface of the first cap 600 and may be engaged with the screw thread 112 formed on an inner surface of the first connecting portion 110. Due to the first cap thread 610, a user may easily attach and detach the first cap 600 to and from the first connecting portion 110.

The first handle 620 may provide a portion that the user may grasp with a hand when attaching the first cap 600 to the first connecting portion 110 or detaching the first cap 600 from the first connecting portion 110. The first handle 620 may have a larger size (e.g., width) than a size (e.g., width) of the portion of the first cap 600 on which the first cap thread 610 is formed.

In a state where the first cap 600 is mounted to the first connecting portion 110 with a maximum depth, the end of the first cap 600 may come into contact with the end of the shaft 300. For example, as shown in FIG. 3, the end of the first cap 600 may come into contact with the upper end of the shaft 300, on which the first serration 310 is formed. Therefore, the first cap 600 may press the upper end of the shaft 300 to prevent the shaft 300 from rotating.

The lower surface of the first handle 620 (e.g., a surface of the first handle 620 facing the first connecting portion 110) may come into contact with an upper end of the first connecting portion 110. The first handle 620 may contact the upper end of the first connecting portion 110 to limit the mounting depth of the first cap 600. For example, when an end of the first cap 600 contacts the end of the shaft 300, the lower surface of the first handle 620 may contact the upper end of the first connecting portion 110. A length of a portion of the first cap 600 inserted into the first connecting portion 110 may be equal to a length from the upper end of the first connecting portion 110 to the upper end of the shaft 300.

The first inner groove 630 may be formed on an upper surface of the first cap 600 (e.g., an upper surface of the first handle 620). The first inner groove 630 may be connected (e.g., coupled) with a tool, such as a wrench, for attaching and detaching the first cap 600 to and from the first connecting portion 110.

The second cap 700 may be mounted to the first connecting portion 110 located at a lower position in the axial direction. As shown in FIG. 4, the second cap 700 may be detachable from the first connecting portion 110 and may press the lower end of the shaft 300 upward. The second cap 700 may be coaxial with the central axis AX while mounted to the first connecting portion 110.

The second cap 700 may include a second cap thread 710, a second handle 720, and a center hole 730.

The second cap thread 710 may be formed on an outer surface of the second cap 700 and may be engaged with the screw thread 112 formed on the inner surface of the first connecting portion 110. Due to the second cap thread 710, the user may easily attach and detach the second cap 700to and from the first connecting portion 110.

The second handle 720 may provide a portion that the user may grasp with their hand when attaching the second cap 700 to the first connecting portion 110 or detaching the second cap 700 from the first connecting portion 110. The second handle 720 may have a larger size (e.g., width) than a size (e.g., width) of the portion of the second cap 700 on which the second cap thread 710 is formed. To allow the user to easily apply force to the second handle 720, the second handle 720 may have an outer surface with a shape in which a plurality of grooves and protrusions are repeatedly formed.

In a state where the second cap 700 is mounted to the first connecting portion 110 with a maximum depth, the end of the second cap 700 may come into contact with the end of the shaft 300. For example, as shown in FIG. 4, the end of the second cap 700 may come into contact with the lower end of the shaft 300 on which the second serration 320 is formed. Therefore, the second cap 700 may press the lower end of the shaft 300 to prevent the shaft 300 from rotating.

An upper surface, for example the surface facing the first connecting portion 110, of the second handle 720 may come into contact with a lower end of the first connecting portion 110. The second handle 720 may contact the lower end of the first connecting portion 110 to limit the mounting depth of the second cap 700. For example, when the end of the second cap 700 contacts the end of the shaft 300, the upper surface of the second handle 720 may contact the lower end of the first connecting portion 110. A length of a portion of the second cap 700 inserted into the first connecting portion 110 may be equal to a length from the lower end of the first connecting portion 110 to the lower end of the shaft 300.

The center hole 730 may be formed at a central position of the second cap 700, in a radial direction of the second cap 700. The center hole 730 may include a screw thread 731 into which a cover 900 is inserted, and which is engaged with the cover 900.

The second cap 700 may further include at least one fixing protrusion 740.

As shown in FIGS. 4 and 5, the at least one fixing protrusion 740 may be formed on the upper end surface of the second cap 700. The second cap 700 may further include a plurality of the fixing protrusions 740 arranged at equal intervals. The fixing protrusion 740 may contact the lower end of the shaft 300 and increase friction to prevent rotation of the shaft 300. For example, as shown in FIG. 5, the fixing protrusion 740 may extend radially on the upper end surface of the second cap 700. The fixing protrusion 740 may have a shape in which a cross-sectional area thereof gradually decreases upward such as, for example, a triangular prism shape.

The fixing protrusion 740 may be engaged with a shaft protrusion 340 of the shaft 300. As shown in FIGS. 4 and 5, the shaft 300 may include a plurality of shaft protrusions 340 at a lower end (e.g., a lower surface of the second serration 320). The plurality of shaft protrusions 340 may interlock with the plurality of fixing protrusions 740, and may increase a frictional force when the second cap 700 presses the shaft 300. Therefore, the rotation of the shaft 300 may be reliably prevented.

The shapes of the fixing protrusion 740 and the shaft protrusion 340 are not specifically limited and may have various structures that alternately interlock to increase the fastening force. For example, the fixing protrusion 740 and the shaft protrusion 340 may include a dome-shaped protrusion or a hemispherical protrusion, or a rectangular protrusion.

The first cap 600 and the second cap 700 may press the shaft 300 at opposite ends of the shaft 300 in the axial direction to fix the first bracket 100 to the shaft 300.

The shaft 300 may include at least one shaft protrusion 340 on an upper end of the shaft 300. In this case, the first cap 600 may also include at least one fixing protrusion corresponding to the at least one shaft protrusion 340.

The set screw 800 may be fastened into the end hole 111 of the first connecting portion 110, and may come into contact with the shaft 300. The end of the set screw 800 that is inserted into the end hole 111 may be in contact with the outer surface of the shaft 300. The set screw 800 may, by pressing the shaft 300, prevent the shaft 300 from rotating by pressing the shaft 300. The set screws 800 may come into contact with the first serration 310 and the second serration 320, respectively. The first serration 310 and the second serration 320 may increase the frictional force between the set screws 800 and the shaft 300, such that rotation of the shaft 300 may be more reliably prevented (see FIG. 5).

With reference to the content described above and FIGS. 6A, 6B, and 6C an installation operation of the mount bracket 10 according to embodiments will be explained below.

With the first bracket 100 and the second bracket 200 rotated to an angle that facilitates the installation, an external device C may be installed on the coupler 400, as shown in FIG. 6A. In this state, the first cap 600 and the second cap 700 may not be mounted on the mount bracket 10, and the first bracket 100, the second bracket 200, and the shaft 300 may rotate.

Next, the first bracket 100 and the second bracket 200 may be positioned at a corner of the installation structure S, as shown in FIG. 6B. The first bracket 100 and the second bracket 200 may rotate to correspond to an angle and a shape of the corner. In addition, the coupler 400 may also rotate together with the shaft 300, and the external device C may be positioned in a desired direction.

Once an angle between the first bracket 100 and the second bracket 200 is determined, the first cap 600 and the second cap 700 may be connected to the first bracket 100 to fix the shaft 300, as shown in FIG. 6C. The first cap 600 and the second cap 700 may be mounted on the first connecting portions 110 located at upper and lower portions of the first bracket 100, respectively, and by pressing an upper end and a lower end of the shaft 300, the shaft 300 may be prevented from rotating. Additionally, the set screws 800 may be inserted into the end holes 111 to further prevent rotation of the shaft 300. The mount bracket 10 may be fixed to the installation structure S by inserting fastening members F into respective first mounting holes 121 of the first bracket 100 and respective second mounting holes 221 of the second bracket 200. Therefore, the first bracket 100 and the second bracket 200 may be fixed in a state adapted to the installation structure S, and the shaft 300 may also be fixed, such that a direction of the external device C may also be fixed.

The mount bracket 10 may be mounted on the installation structure S having corners at a right angle as shown in FIG. 7A, at an acute angle as shown in FIG. 7B, or at an obtuse angle as shown in FIG. 7C. Alternatively, the mount bracket 10 may also be installed in an inner corner of the installation structure S, as shown in FIG. 7D. The mount bracket 10 may be installed on the inner corner of the installation structure S or between two installation structures S that are separated from each other. The direction in which the external device C is oriented may be freely adjusted by the mount bracket 10 before the shaft 300 is fixed, as shown in FIGS. 7E, 7F, and 7G.

The mount bracket 10 according to the embodiments may be adapted to the shape and size of the installation structure by rotating the first bracket 100 and the second bracket 200, and the direction of the external device may be easily adjusted. In addition, the angle and direction adjustment and fixation may be easily achieved by using the first cap 600 and the second cap 700 which are screw-coupled. In addition, the rotation of the shaft 300 may be more reliably prevented in a state where the mount bracket 10 is installed using the set screws 800, the first serration 310, the second serration 320, the shaft protrusions 340, and the fixing protrusions 740.

In an embodiment, the first connecting portion 110 may be connected to one end of the shaft 300, and the second connecting portion 210 may be connected to an opposite end of the shaft 300. For example, the second connecting portion 210 may not be located between two first connecting portions 110, and one or more first connecting portions 110 may be connected to the upper end of the shaft 300, and one or more second connecting portions 210 may be connected to the lower end of the shaft 300. In this case, the first cap 600 may be mounted on the first connecting portion 110, and the second cap 700 may be mounted on the second connecting portion 210. In addition, the end hole 111 may also be formed in each of the first connecting portion 110 and the second connecting portion 210.

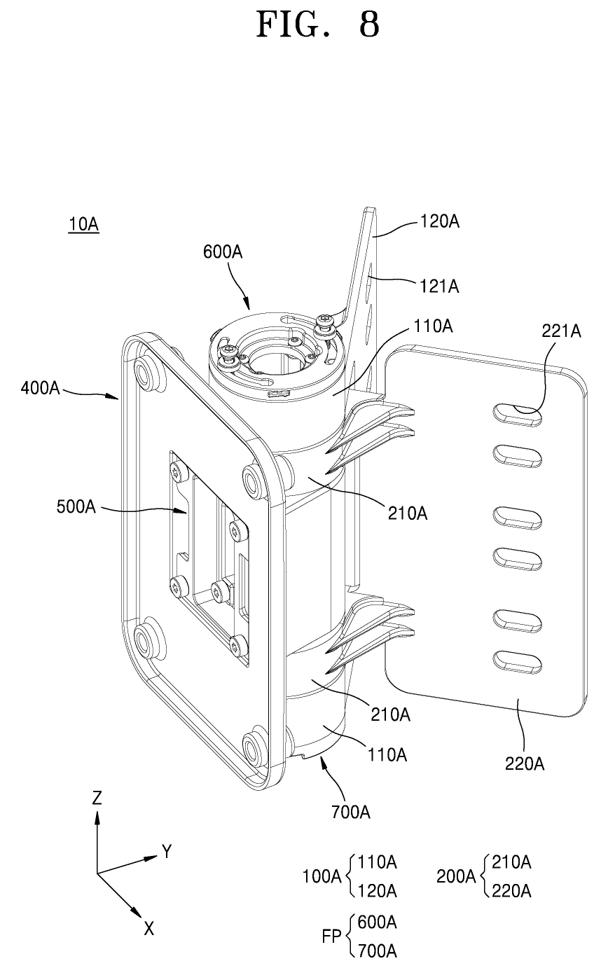

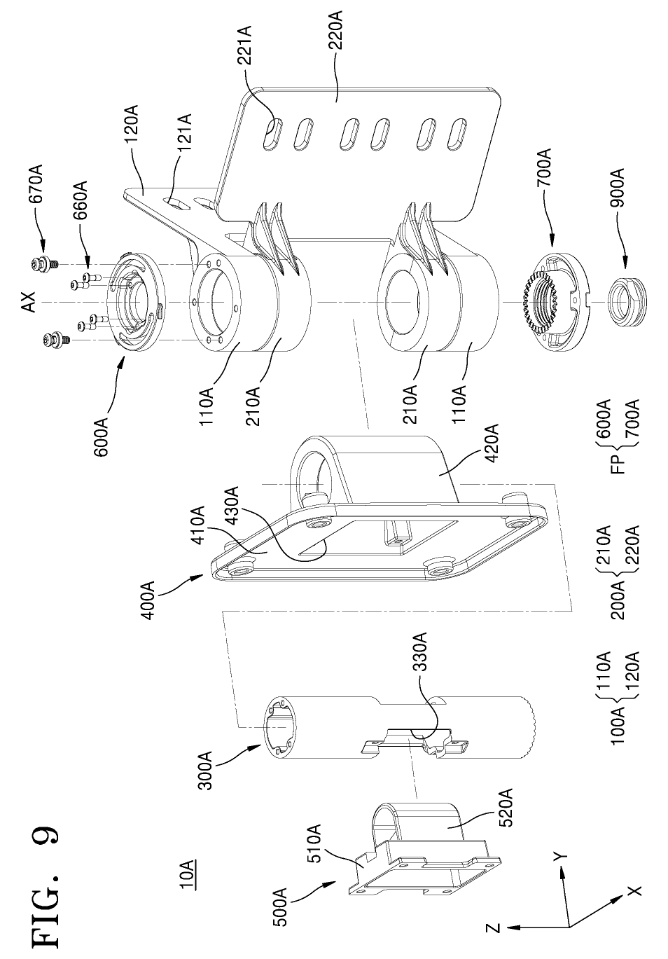

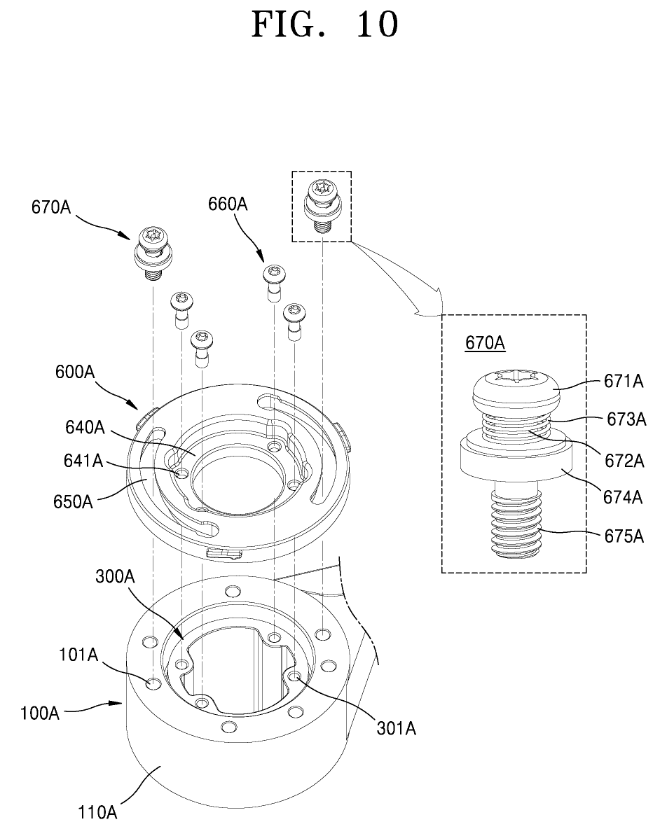

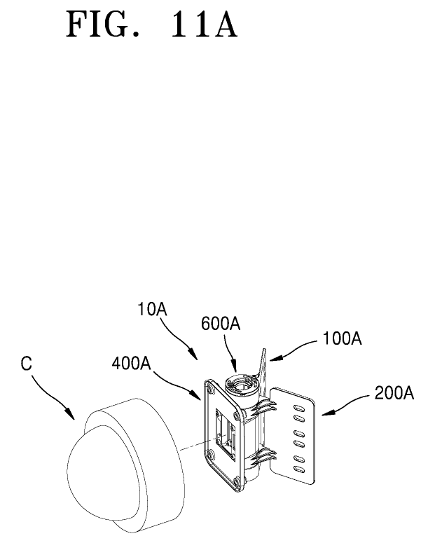

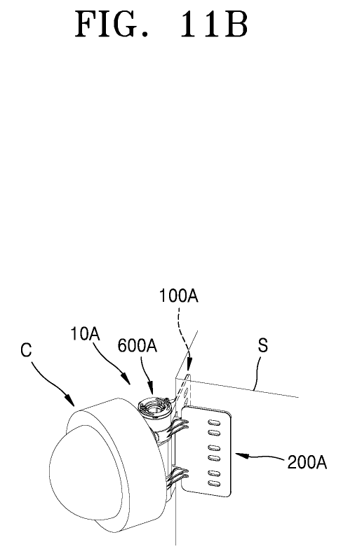

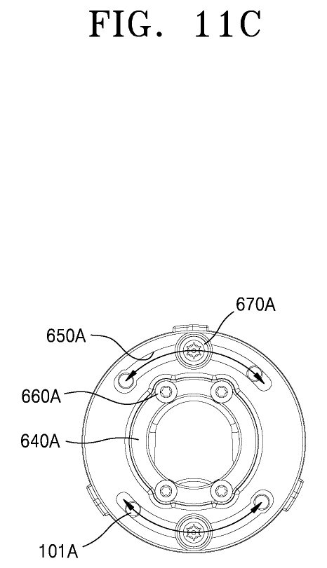

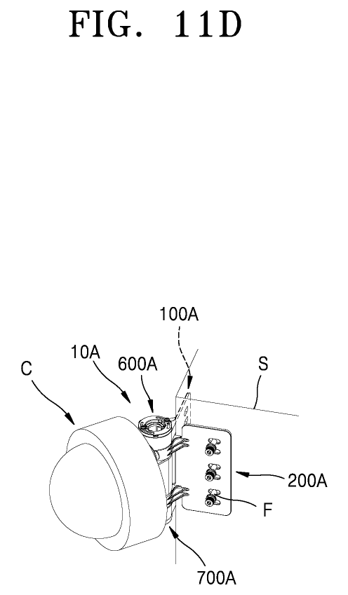

FIG. 8 shows a perspective view of a mount bracket 10A according to embodiments, FIG. 9 shows an exploded perspective view of the mount bracket 10A of FIGS. 8, FIG. 10 shows a first bracket 100A, a shaft 300A, and a first cap 600A according to embodiments, and FIGS. 11A, 11B, 11C, and 11D show an installation operation of the mount bracket 10A according to embodiments.

The mount bracket 10A according to embodiments may include the first bracket 100A, a second bracket 200A, the shaft 300A, a coupler 400A, a shaft locker 500A, the first cap 600A, a second cap 700A, and a cover 900A, wherein the first cap 600A and the second cap 700A are included respectively in two fixing portions FP. The mount bracket 10A, when compared to the mount bracket 10 according to the above described embodiment, may have configurations of the first bracket 100A, the shaft 300A, and the first cap 600A, which are different from those of the mount bracket 10, and the remaining configurations may be the same. For convenience of explanation, the following description will focus on the first bracket 100A, the shaft 300A, and the first cap 600A. For the same components, “A” is added after the reference numerals, and descriptions thereof may be replaced with those of the embodiments described above.

As shown in FIGS. 8 and 9, the first bracket 100A may include at least one first connecting portion 110A and a first wing portion 120A, and the first wing portion 120A may include at least one first mounting hole 121A. The second bracket 200A may include at least one second connecting portion 210A and a second wing portion 220A, and the second wing portion 220A may include at least one second mounting hole 221A. The shaft 300A may include a coupling hole 330A. The coupler 400A may include a mounting plate 410A, a first sleeve 420A, and an opening 430A. The shaft locker 500A may include a coupling plate 510A and a second sleeve 520A.

As shown in FIG. 10, among a plurality of first connecting portions 110A, the first connecting portion 110A connected to an upper portion of the shaft 300A may include at least one outer fastening hole 101A. The at least one outer fastening hole 101A may be formed on (or in) an upper surface of the first connecting portion 110A and may correspond to one or more outer holes 650A of the shaft 300A. The outer fastening hole 101A may be fastened with an outer screw 670A inserted through the outer hole 650A to secure the first cap 600A and the first connecting portion 110A. The first connecting portion 110A may include a plurality of outer fastening holes 101A (e.g., seven). The plurality of outer fastening holes 101A may be arranged at the same or different intervals on (or in) the upper surface of the first connecting portion 110A. Depending on mounting positions of the first cap 600A and the first connecting portion 110A, some of the outer fastening holes 101A may not be exposed through the outer holes 650A. The plurality of outer fastening holes 101A may provide convenience to the user when fixing the first bracket 100A after angle adjustment of the first bracket 100A.

The shaft 300A may include at least one shaft hole 301A. As shown in FIG. 10, the shaft hole 301A may be formed on (or in) the upper surface of the shaft 300A. The plurality of shaft holes 301A may correspond, respectively, to a plurality of inner holes 641A formed on (or in) the fixing portion FP. The plurality of shaft holes 301A may correspond, respectively, to a plurality of inner holes 641A formed on (or in) the fixing portion FP. Inner screws 660A may be fastened to the plurality of shaft holes 301A through the inner holes 641A.

When adjusting the angle and direction of the mount bracket 10A, the shaft 300A may be in a state of being coupled to the first cap 600A via screw coupling between the plurality of shaft holes 301A and the plurality of inner holes 641A. Afterward, once the angles of the first bracket 100A and the second bracket 200A are determined and the direction of the coupler 400A is determined, the outer screw 670A may be fastened to the outer fastening hole 101A through the outer hole 650A, such that the first connecting portion 110A, the shaft 300A, and the first cap 600A may be coupled together and rotation of the shaft 300A may be prevented.

The first cap 600A may be connected to the first connecting portion 110A and the shaft 300A, and may prevent the rotation of the first bracket 100A and the shaft 300A. As shown in FIG. 10, the first cap 600A may have a ring shape and may be connected to both the first connecting portion 110A and the shaft 300A. The first cap 600A may be connected to both the first connecting portion 110A and the shaft 300A, and the shaft locker 500A may be connected to the shaft 300A and the coupler 400A, such that the first connecting portion 110A and the shaft 300A may be prevented from rotating.

The first cap 600A may include a stepped portion 640A, the inner hole 641A, the outer hole 650A, at least one inner screw 660A, and at least one outer screw 670A.

The stepped portion 640A may be positioned below the upper end of the first cap 600A and may be positioned around an opening of the first cap 600A. A plurality of inner holes 641A may be formed in the stepped portion 640A. The plurality of inner holes 641A may correspond, respectively, to the plurality of shaft holes 301A, and may each be connected to a corresponding shaft hole 301A via a corresponding inner screw 660A.

The outer hole 650A may be formed on an outer side of the stepped portion 640A in a radial direction of the first cap 600A. The outer hole 650A may have an elongated hole shape rather than a circular shape. For example, as shown in FIG. 10, two outer holes 650A may each have an arc shape extending along the circumferential direction of the first cap 600A. The outer holes 650A may correspond, respectively, to subsets of the plurality of outer fastening holes 101A. Therefore, after a turning angle of the first bracket 100A is determined by the user, the outer screw 670A may be moved along the outer hole 650A and fastened to the outer fastening hole 101A, such that the first cap 600A may be connected to the first bracket 100A. The outer hole 650A may be provided in plural as a plurality of outer holes 650A (e.g., two).

The inner screw 660A may be fastened to the shaft hole 301A via the inner hole 641A to secure the first cap 600A to the shaft 300A. For example, the inner screws 660A may be provided in the same number as the inner holes 641A.

Each outer screw 670A may be fastened to a corresponding outer fastening hole 101A through a corresponding outer hole 650A to fix the first cap 600A to the first bracket 100A. After the inner screws 660A are fastened to the shaft holes 301A, respectively, the rotation angle of the first bracket 100A may be adjusted, and then the outer screws 670A may be fastened into the outer fastening holes 101A, respectively.

The outer screws 670A may, until fastened into the outer fastening holes 101A, allow rotation of the first bracket 100A. For example, even in a state where each inner screw 660A is fastened into a corresponding shaft hole 301A, when the outer screws 670A are not fastened into the outer fastening holes 101A, respectively, the first cap 600A may rotate together with the shaft 300A, and thus the first bracket 100A may also rotate about the shaft 300A. Here, the outer screw 670A may be inserted into the outer hole 650A but may not be fastened into the outer fastening hole 101A, (e.g., in a pre-engaged state), and may move freely in a circumferential direction along the outer hole 650A. In addition, the outer screws 670A may not be disengaged from the outer holes 650A, respectively, in the axial direction. Therefore, after determining the angle of the first bracket 100A, the outer screws 670A may be moved and fastened, by the user, to the outer fastening holes 101A, respectively, to finally fix the first cap 600A to the first bracket 100A. Accordingly, the user may determine the angle of the first bracket 100A while the first cap 600A is stably coupled to the shaft 300A, and fix the first bracket 100A by fixing the first cap 600A to the first bracket 100A.

As shown in FIG. 10, each outer screw 670A may include a head 671A, a screw shaft 672A, a spring 673A, a rib 674A, and a screw thread 675A.

The head 671A may include a groove into which a tool is inserted, and the screw shaft 672A may extend downward from the bottom surface of the head 671A. The rib 674A may be provided around the screw shaft 672A, and the spring 673A may be positioned between the rib 674A and the head 671A. The spring 673A may be wound around the screw shaft 672A and may be compressed between the rib 674A and the head 671A when the user presses the head 671A. The screw thread 675A may be fastened to a thread of the outer fastening hole 101A. Therefore, until the head 671A is pressed by the user to fasten the screw thread 675A into the outer fastening hole 101A, the outer screw 670A may move freely in the circumferential direction along the outer hole 650A.

With reference to the content described above and FIGS. 11A, 11B, 11C, and 11D an installation operation of the mount bracket 10A according to embodiments will be explained.

With the first bracket 100A and the second bracket 200A rotated to an angle that facilitates the installation, the external device C may be installed on the coupler 400A, as shown in FIG. 11A. In this state, the first cap 600A may be fastened to the shaft 300A but not to the first bracket 100A. Additionally, the second cap 700A may not be fastened to the first bracket 100A, and the first bracket 100A, second bracket 200A, and shaft 300A may be rotatable.

Next, the first bracket 100A and the second bracket 200A may be positioned at a corner of the installation structure S, as shown in FIG. 11B. The first bracket 100A and the second bracket 200A may rotate to correspond to an angle and a shape of the corner. In addition, the coupler 400A may also rotate together with the shaft 300A, and the external device C may be arranged in a desired direction.

Once the angle between the first bracket 100A and the second bracket 200A is determined, the first cap 600A may be fixed to the first bracket 100A, as shown in FIG. 11C. The outer screws 670A may, while being moved in a circumferential direction, be pressed and screw-fastened by the user into the outer fastening holes 101A. Accordingly, the first cap 600A and the first bracket 100A may be fastened to each other. In addition, the second cap 700A may be connected to the first bracket 100A to fix the shaft 300A, as shown in FIG. 11D. The second cap 700A may be mounted on the first connecting portion 110A located at a lower portion of the first bracket 100A, and by pressing a lower end of the shaft 300A, the shaft 300A may be prevented from rotating. The mount bracket 10A may be fixed to the installation structure S by inserting the fastening members F into the first mounting holes 121A of the first bracket 100A and the second mounting holes 221A of the second bracket 200A. Therefore, the first bracket 100A and the second bracket 200A may be fixed in a state adapted to the installation structure S, and the shaft 300A may also be fixed, such that a direction of the external device C may also be fixed.

According to embodiments, because a screw-coupled mechanism is included in the first cap 600A, the mount bracket 10A may more firmly connect (e.g., couple) the first cap 600A to the first bracket 100A. Additionally, with the first cap 600A connected (e.g., coupled) to the shaft 300A but not connected (e.g., coupled) to the first bracket 100A, the angle of the first bracket 100A may be adjusted by the user by freely moving the outer screws 670A in the circumferential direction.

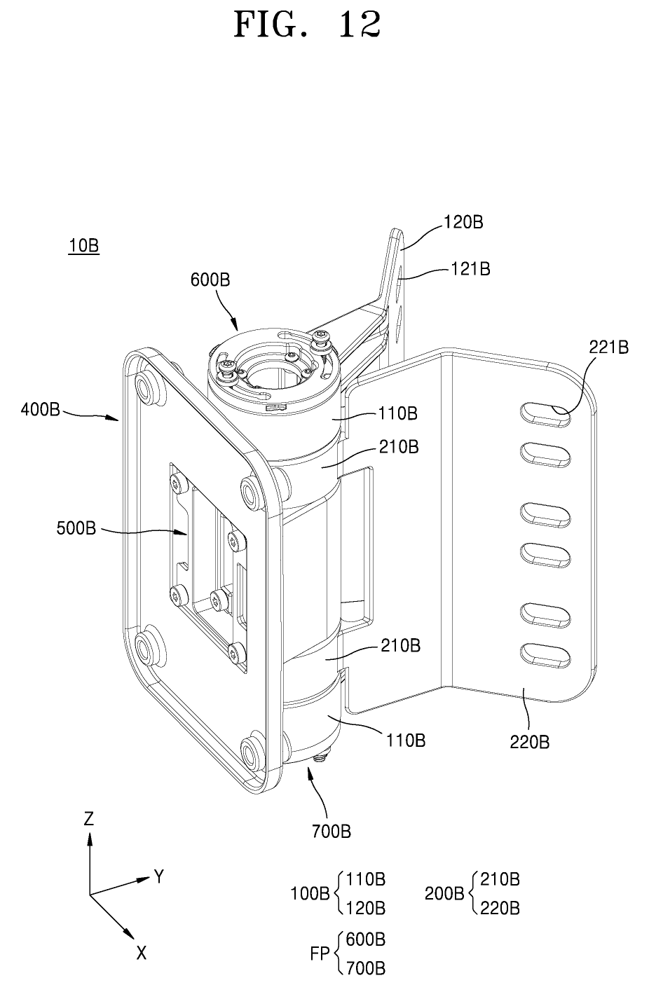

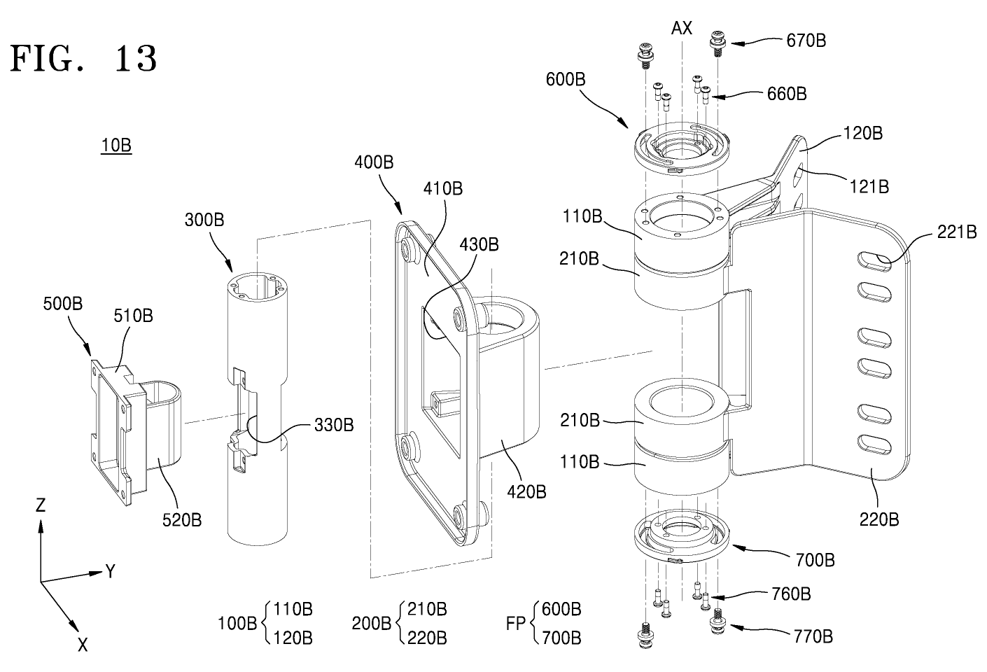

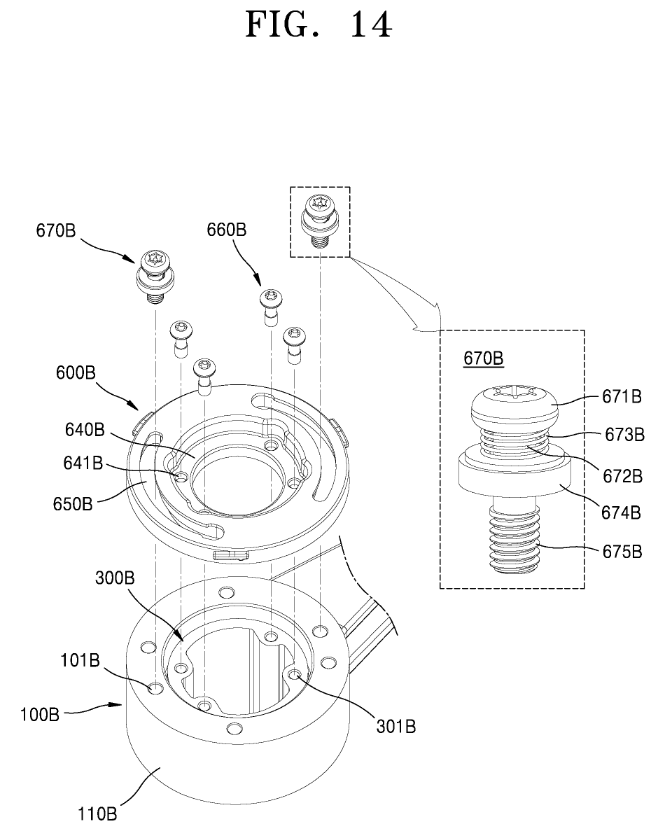

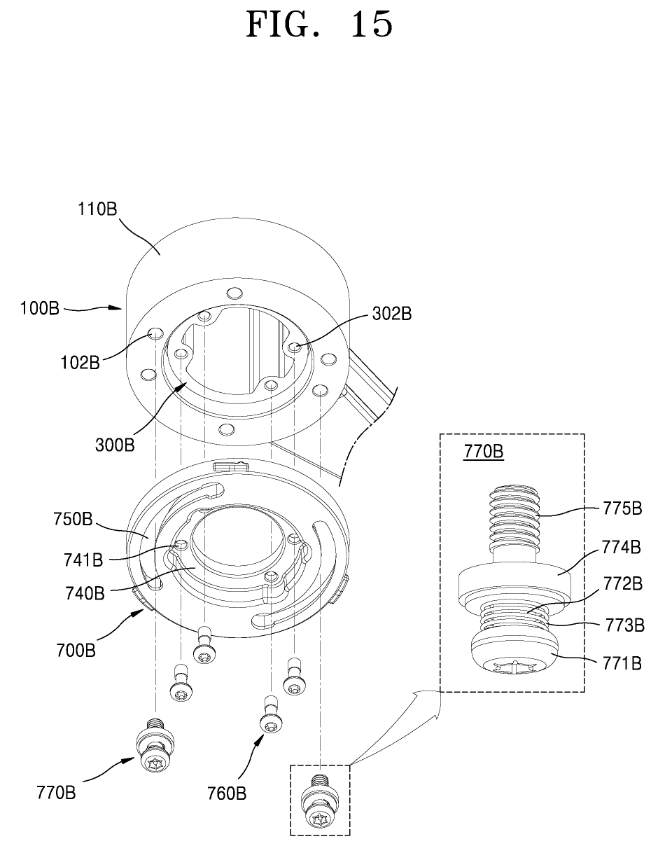

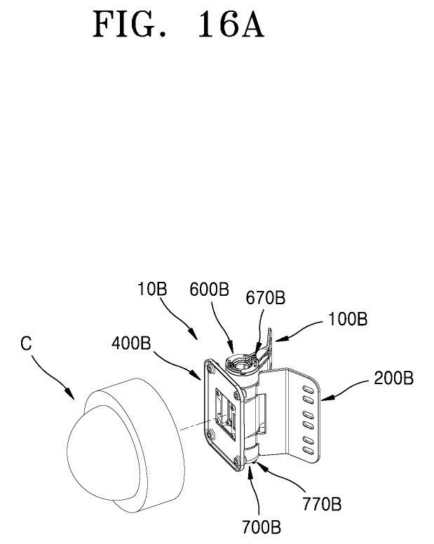

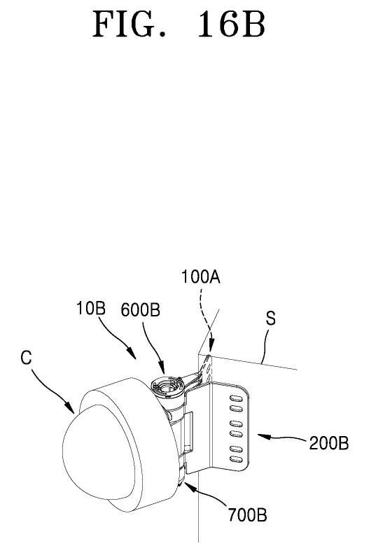

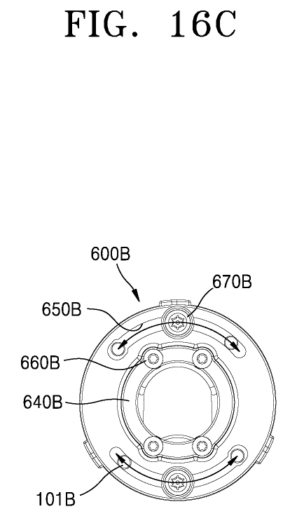

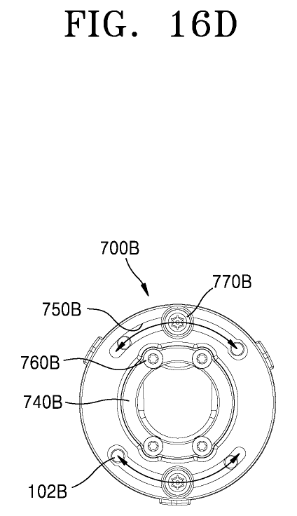

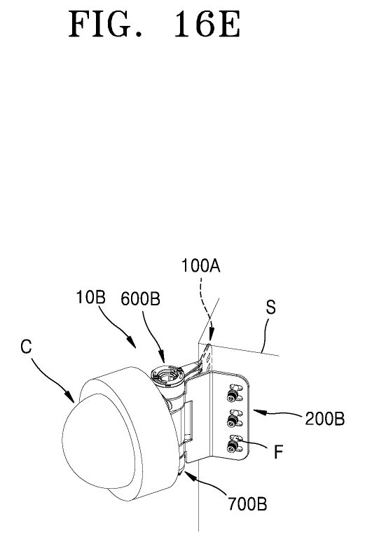

FIG. 12 shows a perspective view of a mount bracket 10B according to embodiment, FIG. 13 shows an exploded perspective view of the mount bracket 10B of FIGS. 12, FIG. 14 shows a first bracket 100B, a shaft 300B, and a first cap 600B according to embodiments, FIG. 15 shows the first bracket 100B, the shaft 300B, and a second cap 700B according to embodiments, and FIGS. 16A, 16B, 16C, 16D, and 16E show an installation operation of the mount bracket 10B according to embodiments.

The mount bracket 10B according to embodiments may include the first bracket 100B, a second bracket 200B, the shaft 300B, a coupler 400B, a shaft locker 500B, the first cap 600B, the second cap 700B, and a cover (see cover 900 of FIG. 2), wherein the first cap 600b and the second cap 700B may be referred to as respective fixing portions FP. The mount bracket 10B, when compared to the mount bracket 10A according to the embodiment described above, may have configurations of the first bracket 100B, the shaft 300B, and the second cap 700B, which are different from those of the mount bracket 10A, and the remaining configurations may be the same. For convenience of explanation, the following description will focus on the first bracket 100B, the shaft 300B, and the second cap 700B. For the same components, “B” is added after the reference numerals, and descriptions thereof may be replaced with those of the embodiments described above.

As shown in FIGS. 12 and 13, the first bracket 100B may include at least one first connecting portion 110B and a first wing portion 120B. The first connecting portion 110B may include at least one outer fastening hole 101B, and the first wing portion 120B may include at least one first mounting hole 121B. The second bracket 200B may include at least one second connecting portion 210B and a second wing portion 220B. The second wing portion 220B may include at least one second mounting hole 221B. The shaft 300B may include at least one shaft hole 301B and a coupling hole 330B. The coupler 400B may include a mounting plate 410B, a first sleeve 420B, and an opening 430B. The shaft locker 500B may include a coupling plate 510B and a second sleeve 520B. Also, as shown in FIG. 14, the first cap 600B may include a stepped portion 640B, at least one inner hole 641B, at least one outer hole 650B, at least one inner screw 660B, and at least one outer screw 670B. The outer screw 670B may include a head 671B, a screw shaft 672B, a spring 673B, a rib 674B, and a screw thread 675B.

As shown in FIG. 15, among a plurality of first connecting portions 110B, the first connecting portion 110B connected to the upper portion of the shaft 300B may include at least one outer fastening hole 102B. The outer fastening hole 102B may be formed on (or in) a lower end surface of the first connecting portion 110B and may correspond to the outer hole 750B of the second cap 700B. The outer fastening hole 101B may be fastened with an outer screw 770B inserted through the outer hole 750B to secure the second cap 700B and the second connecting portion 210B. The first connecting portion 110B may include a plurality of outer fastening holes 102B (e.g., six). The plurality of outer fastening holes 102B may be arranged at the same or different intervals on (or in) the lower end surface of the first connecting portion 110B. Depending on the mounting position of the second cap 700B and the first connecting portion 110B, some of the outer fastening holes 102B may not be exposed through the outer holes 750B. The plurality of outer fastening holes 102B may provide convenience to the user when fixing the first bracket 100B after angle adjustment of the first bracket 100B.

The shaft 300B may include at least one shaft hole 302B. As shown in FIG. 15, the shaft hole 302B may be formed on (or in) a lower end surface of the shaft 300B. The shaft 300B may include a plurality of shaft holes 302B. Each of the plurality of shaft holes 302B may correspond to a respective one of inner holes 741B of the second cap 700B. Inner screws 760B may be fastened to the plurality of shaft holes 302B through the inner holes 741B.

When adjusting the angle and direction of the mount bracket 10B, the shaft 300B may be connected to the second cap 700B through the plurality of shaft holes 302B and the plurality of inner holes 741B. Afterward, once the angles of the first bracket 100B and the second bracket 200B are determined and the direction of the coupler 400B is determined, the outer screws 770B may be fastened into the outer fastening holes 102B through the outer holes 750B, such that the first connecting portion 110B, the shaft 300B, and the second cap 700B may be coupled together and rotation of the shaft 300B may be prevented.

The second cap 700B may be connected to the first connecting portion 110B and the shaft 300B and may prevent rotation of the first bracket 100B and the shaft 300B. As shown in FIG. 10, the second cap 700B may have a ring shape and may be connected to both the first connecting portion 110B and the shaft 300B. The second cap 700B may be connected to both the first connecting portion 110B and the shaft 300B, and the shaft locker 500B may be connected to the shaft 300B and the coupler 400B, such that the first connecting portion 110B and the shaft 300B may be prevented from rotating.

The second cap 700B may include a stepped portion 740B, the inner holes 741B, the outer holes 750B, the inner screws 760B, and the outer screws 770B. The configuration of the second cap 700B may be the same as the configuration of the first cap 600B, and a repeated description thereof may be omitted.

With reference to the contend described above and FIGS. 16A, 16B, 16C, 16D, and 16E, an installation operation of the mount bracket 10B according to embodiments will be explained.

With the first bracket 100B and the second bracket 200B rotated to an angle that facilitates the installation, the external device C may be installed on the coupler 400B, as shown in FIG. 16A. In this state, the first cap 600B and the second cap 700B may be fastened to the shaft 300B but not to the first bracket 100B. The first bracket 100B, the second bracket 200B, and the shaft 300B may be rotatable.

Next, the first bracket 100B and the second bracket 200B may be positioned at a corner of the installation structure S, as shown in FIG. 16B. The first bracket 100B and the second bracket 200B may rotate to correspond to an angle and a shape of the corner. In addition, the coupler 400B may also rotate together with the shaft 300B, and the external device C may be arranged in a desired direction.

Once the angle between the first bracket 100B and the second bracket 200B is determined, the first cap 600B may be fixed to the first bracket 100B, as shown in FIG. 16C, and the second cap 700B may be fixed to the first bracket 100B, as shown in FIG. 16D. The outer screw 670B may, while being moved in a circumferential direction, be pressed and screw-fastened by the user into the outer fastening hole 101B. Accordingly, the first cap 600B and the first bracket 100B may be coupled. Additionally, the outer screw 770B may, while being moved in a circumferential direction, be pressed and screw-fastened by the user into the outer fastening hole 102B. Accordingly, the second cap 700B and the first bracket 100B may be connected (e.g., coupled), as shown in FIG. 16E. The mount bracket 10B may be fixed to the installation structure S by inserting a fastening member F into each first mounting hole 121B of the first bracket 100B and each second mounting hole 221B of the second bracket 200B. Therefore, the first bracket 100B and the second bracket 200B may be fixed in a state adapted to the installation structure S, and the shaft 300B may also be fixed, such that a direction of the external device C may also be fixed.

According to the embodiments, because the first cap 600B and the second cap 700B include a screw-coupling mechanism, the mount bracket 10B may more firmly connected (e.g., couple) the first cap 600B and the second cap 700B to the first bracket 100B. The first cap 600B and the second cap 700B may support opposite ends of the first bracket 100B in the axial direction such that an excessive moment is not applied to one side. In addition, with the first cap 600B coupled to the shaft 300B but not connected (e.g., coupled) to the first bracket 100B, and the second cap 700B also connected (e.g., coupled) to the shaft 300B but not connected (e.g., coupled) to the first bracket 100B, the angle of the first bracket 100B may be adjusted by the user by freely moving the outer screws 670B and 770B in the circumferential direction.

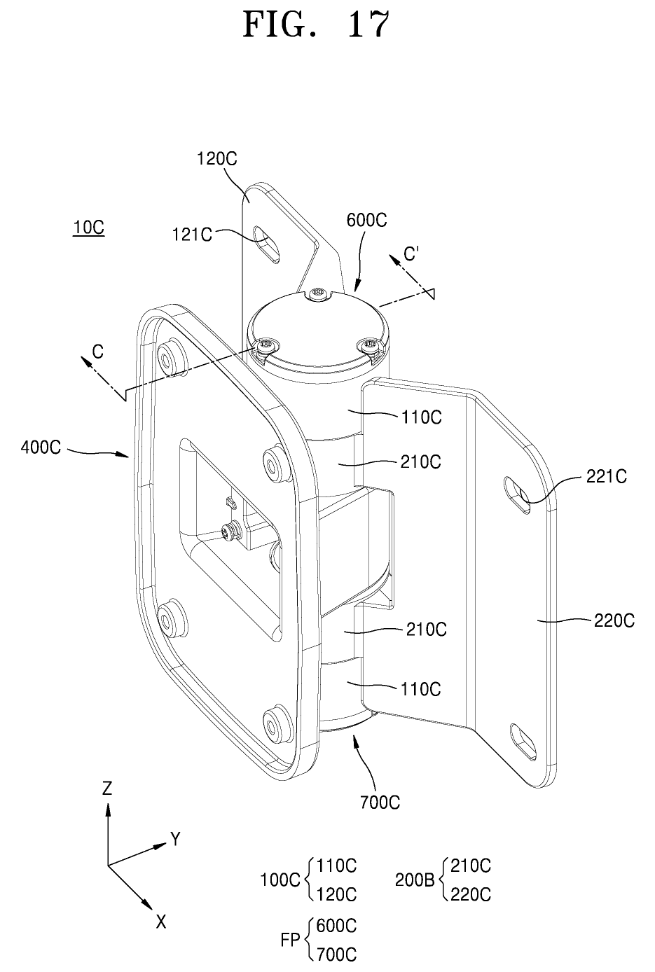

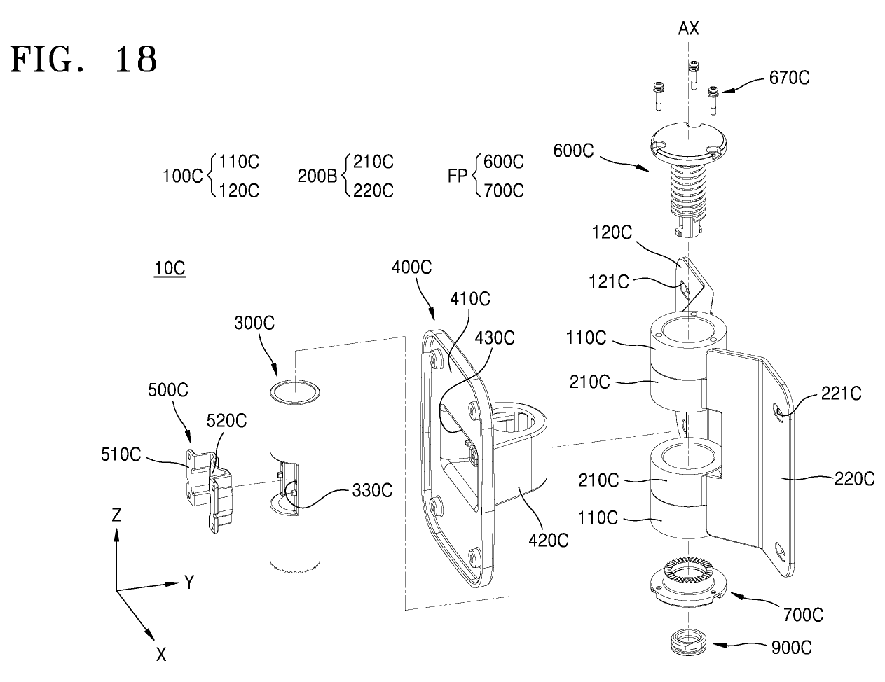

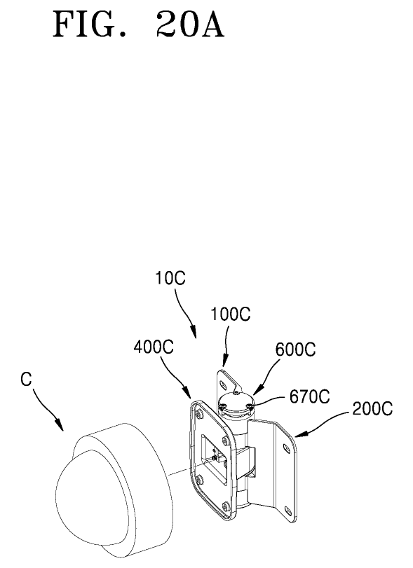

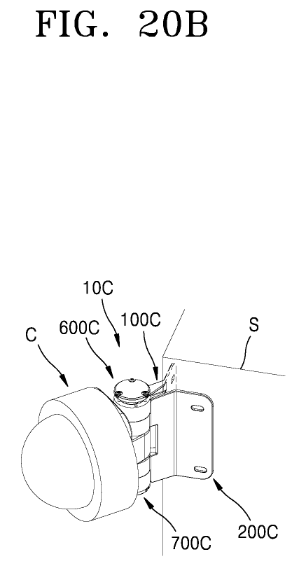

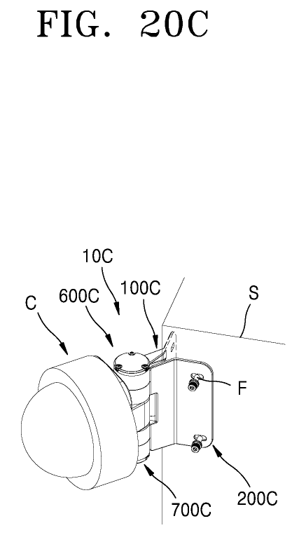

FIG. 17 shows a perspective view of a mount bracket 10C according to embodiments, FIG. 18 shows an exploded perspective view of the mount bracket 10C of FIGS. 17, FIGS. 19A and 18B show a fixing operation of the mount bracket 10C according to embodiments, and FIGS. 20A, 20B, and 20C show an installation operation of the mount bracket 10C according to embodiments.

The mount bracket 10C according to embodiments may include a first bracket 100C, a second bracket 200C, a shaft 300C, a coupler 400C, a shaft locker 500C, a first cap 600C, a second cap 700C, and a cover 900C, wherein the first cap 600C and the second cap 700C may be referred to as respective fixing portions FP. The mount bracket 10C, when compared to the mount bracket 10 according to the embodiment described above, may have configurations of the first bracket 100C, the shaft 300C, the shaft locker 500C, and the first cap 600C, which are different from those of the mount bracket 10, and the remaining configurations may be the same. For convenience of explanation, the following description will focus on the first bracket 100C, the shaft 300C, the shaft 300C, and the first cap 600C. For the same components, “C” is added after the reference numerals, and descriptions thereof may be replaced with those of the embodiments described above.

As shown in FIGS. 17 and 18, the first bracket 100C may include at least one first connecting portion 110C and a first wing portion 120C, and the first wing portion 120C may include at least one first mounting hole 121C. The second bracket 200C may include at least one second connecting portion 210C and a second wing portion 220C, and the second wing portion 220C may include at least one second mounting hole 221C. The shaft 300C may include a coupling hole 330C. The coupler 400C may include a mounting plate 410C, a first sleeve 420C, and an opening 430C. The shaft locker 500C may include a coupling plate 510C and a second sleeve 520C.

The first bracket 100C may include at least one outer fastening hole 101C.

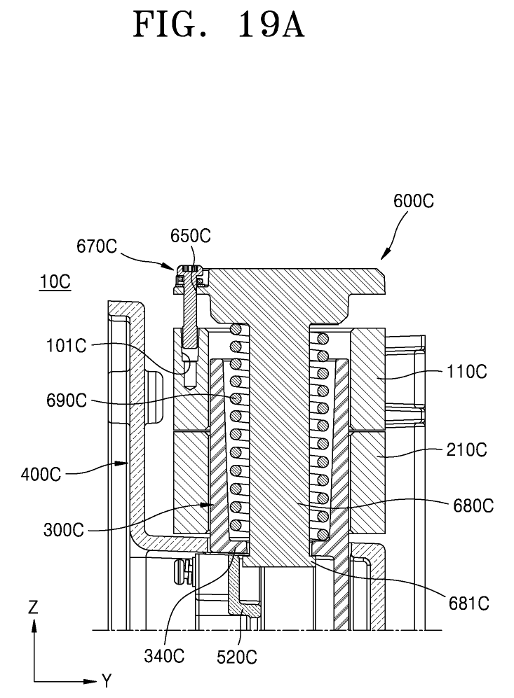

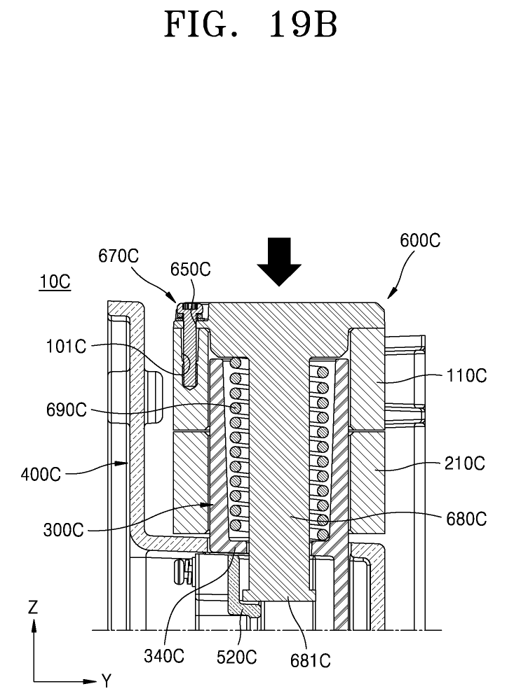

As shown in FIGS. 19A and 19B, a plurality of the outer fastening holes 101C may be formed on (or in) an upper surface of a first connecting portion 110C positioned at an upper portion among a plurality of first connecting portions 110C of the first bracket 100C. Outer screws 670C may be inserted into the outer fastening holes 101C through outer holes 650C.

The shaft 300C may include a stopper 340C.

As shown in FIGS. 19A and 19B, the stopper 340C may extend radially inward along an inner surface of a lower end portion of the shaft 300C. The stopper 340C may include an opening into which an anchor 680C may be inserted. As shown in FIG. 19A, the stopper 340C may support an anchor spring 690C to prevent downward displacement of the stopper 340C. In addition, as shown in FIG. 19B, the stopper 340C may prevent the anchor 680C from coming off the shaft 300C by contacting the lower end protrusion 681C with a lower surface of the stopper 340C. The stopper 340C may restrict a rising height of the lower end protrusion 681C.

The stopper 340C may have a ring shape or include a plurality of segments segmented in a circumferential direction.

The second sleeve 520C may support the lower end protrusion 681C of the anchor 680C. As shown in FIG. 19B, a portion of the second sleeve 520C may extend inward in the radial direction of the shaft 300. When the anchor 680C is inserted to a maximum depth, the lower end protrusion 681C may come into contact with an extension of the second sleeve 520C to support the anchor 680C.

The first cap 600C may include the at least one outer hole 650C, the at least one outer screw 670C, the anchor 680C, and the anchor spring 690C.

The outer hole 650C may correspond to the outer fastening hole 101C and may have the outer screw 670C inserted therein. For example, a plurality of outer holes 650C may be formed in a head portion of the anchor 680C. When the outer screw 670C is inserted into the outer hole 650C but not into the outer fastening hole 101C, the first cap 600C may not be fixed to the shaft 300C and the first connecting portion 110C. In this state, an angle of the first bracket 100C may be adjusted by the user, and then the outer screw 670C may be fastened into the outer fastening hole 101C. The outer screw 670C may be wound with a spring, and a lower portion of the outer screw 670C may be in a state of being pre-engaged with the outer fastening hole 101C. Subsequently, when the anchor 680C and the outer screw 670C are pressed by the user, the spring may be compressed and the outer screw 670C may be screwed into the outer fastening hole 101C.

The anchor 680C may be coupled to the shaft 300C and the first connecting portion 110C. For example, as shown in FIGS. 19A and 19B, at least a portion of the anchor 680C may be accommodated inside the first connecting portion 110C located at the upper position and the shaft 300C. The anchor 680C may include the head portion, an anchor shaft extending from the head portion, and the lower end protrusion 681C that is located at a lower end of the anchor shaft and has a diameter larger than a diameter of the anchor shaft. When the anchor 680C rises, the lower end protrusion 681C may come into contact with the stopper 340C, such that the anchor 680C may be prevented from coming off. Additionally, when the anchor 680C descends, the lower end protrusion 681C may come into contact with the second sleeve 520C, such that a maximum insertion depth of the anchor 680C may be limited and the anchor 680C may not excessively press the shaft 300C.

The anchor spring 690C may be wound around the anchor 680C, especially around the anchor shaft thereof. As shown in FIG. 19A, when the anchor spring 690C is not subjected to a downward force, the head portion of the anchor 680C may be separated from the upper end of the shaft 300C by the anchor spring 690C. In addition, the outer screw 670C may not be fastened into the outer fastening hole 101C. In this state, the first bracket 100C and the shaft 300C may rotate freely. As shown in FIG. 19B, when the anchor spring 690C is pressed downward, the anchor 680C may descend until the head portion of the anchor 680C comes into contact with the upper end of the shaft 300C. The outer screw 670C may also be lowered and fastened into the outer fastening hole 101C. The shaft 300C may be prevented from rotating as the anchor 680C presses the shaft 300C downward, and the first cap 600C and the first bracket 100C may be fastened as the outer screw 670C is fastened into the first connecting portion 110C. Therefore, the rotation of the first bracket 100C and the shaft 300C may be prevented.

Because the anchor 680C moves downward by being subjected to a force, and the first bracket 100C and the shaft 300C may rotate freely until the outer screw 670C is fully fastened into the first connecting portion 110C, the angle of the first bracket 100C may be freely adjusted by the user. In addition, even in this state, the anchor 680C may not be disengaged from the shaft 300C, and the outer screw 670C may also remain pre-engaged with the outer fastening hole 101C, such that the angle of the first bracket 100C may be stably adjusted by the user.

In an embodiment, the anchor 680C may, by pressing the anchor spring 690C to be compressed, axially press the upper end of the shaft 300C.

In an embodiment, the anchor spring 690C may separate the anchor 680C from the upper end of the shaft 300C in an unpressed state.

In an embodiment, when the anchor spring 690C is in the unpressed state, the outer screw 670C may be pre-engaged with the outer fastening hole 101C, and when the anchor spring 690C is in the pressed state, the anchor 680C may contact the upper end of the shaft 300C and the outer screw 670C may be fastened into the outer fastening hole 101C.

With reference to the content described above and FIGS. 20A, 20B, and 20C, an installation operation of the mount bracket 10C according to embodiments will be explained.

With the first bracket 100C and the second bracket 200C rotated to an angle that facilitates the installation, the external device C may be installed on the coupler 400C, as shown in FIG. 20A. In this state, the first cap 600C may be pre-engaged with the first bracket 100C and the shaft 300C, and the second cap 700C may not be fastened to the first bracket 100C. The first bracket 100C, the second bracket 200C, and the shaft 300C may be rotatable.

Next, the first bracket 100C and the second bracket 200C may be positioned at a corner of the installation structure S, as shown in FIG. 20B. The first bracket 100C and the second bracket 200C may rotate to correspond to an angle and a shape of the corner. In addition, the coupler 400C may also rotate together with the shaft 300C, and the external device C may be arranged in a desired direction.

Once the angle between the first bracket 100C and the second bracket 200C is determined, the first cap 600C may be fixed to the shaft 300C and the first bracket 100C, and the second cap 700C may be fixed to the first bracket 100C, as shown in FIG. 20C. The anchor 680C may be pressed by the user such that the head portion of the anchor 680C presses the upper end of the shaft 300C, and the second cap 700C presses a lower end of the shaft 300C. In addition, the outer screw 670C may be fastened into the outer fastening hole 101C. The mount bracket 10C may be fixed to the installation structure S by inserting the fastening member F into the first mounting hole 121C of the first bracket 100C and the second mounting hole 221C of the second bracket 200C. Therefore, the first bracket 100C and the second bracket 200C may be fixed in a state adapted to the installation structure S, and the shaft 300C may also be fixed, such that a direction of the external device C may also be fixed.

According to the embodiments, because the first cap 600C may include an anchor and spring coupling mechanism, the first cap 600C may press the shaft 300C more strongly. Therefore, the rotation of the shaft 300C may be more reliably prevented.

The mount bracket according to some embodiments of the present disclosure allows for the installation of external devices on various installation structures using a single mount bracket by adapting the bracket according to the shape and size of the installation structure.

The mount bracket according to some embodiments of the present disclosure improves user installation convenience, making angle and direction adjustment easy, and allows the bracket to be easily fixed.

The effects of embodiments of the present disclosure described above are illustrative and do not limit the scope of the present disclosure. In addition, various other effects may be achieved by embodiments of the present disclosure in addition to the effects described above.

Embodiments described herein should be considered in a descriptive sense only and not for purposes of limitation. Descriptions of features or aspects within each embodiment of the present disclosure should typically be considered as available for other similar features or aspects in other embodiments of the present disclosure. While one or more embodiments have been described with reference to the figures, it will be understood by those of ordinary skill in the art that various changes in form and details may be made therein without departing from the spirit and scope of the present disclosure.

What is claimed is:

1. A mount bracket comprising:
a shaft;
a first bracket comprising:
at least one first connecting portion configured to be connected to the shaft; and
a first wing portion extending from the at least one first connecting portion;
a second bracket comprising:
at least one second connecting portion configured to be connected to the shaft; and
a second wing portion extending from the at least one second connecting portion;
a coupler configured to be connected to the shaft; and
at least one fixing portion configured to be connected to the at least one first connecting portion or the at least one second connecting portion, the at least one fixing portion further configured to prevent rotation of the shaft,
wherein the first bracket and the second bracket are configured to be rotatably connected to the shaft such that an angle between the first wing portion and the second wing portion is adjustable.

2. The mount bracket of claim 1, wherein the at least one fixing portion is further configured to fix the first bracket or the second bracket to the shaft.

3. The mount bracket of claim 1, wherein the at least one fixing portion comprises at least one cap that is configured to be mounted on the at least one first connecting portion or the at least one second connecting portion, the at least one cap configured to press the shaft in an axial direction of the shaft.

4. The mount bracket of claim 1, wherein the at least one fixing portion comprises:
a first cap configured to screw-couple to an inner surface of a first connecting portion or a second connecting portion located at an upper position in an axial direction of the shaft among the at least one first connecting portion or the at least one second connecting portion, the first cap configured to contact an upper end of the shaft; and
a second cap configured to screw-couple to an inner surface of a first connecting portion or a second connecting portion located at a lower position in the axial direction among the at least one first connecting portion or the at least one second connecting portion, the second cap configured to contact a lower end of the shaft, and
wherein the first cap and the second cap are configured to fix the shaft by pressing the upper end of the shaft and the lower end of the shaft, respectively.

5. The mount bracket of claim 3, wherein the at least one cap comprises a fixing protrusion, the fixing protrusion configured to contact an end of the shaft, and
wherein the shaft comprises a shaft protrusion on a surface of the shaft, the shaft protrusion configured to contact the fixing protrusion.

6. The mount bracket of claim 1, wherein the at least one first connecting portion or the at least one second connecting portion comprises an end hole, and
wherein the mount bracket further comprises a set screw that is configured to be inserted into the end hole and contact an outer surface of the shaft.

7. The mount bracket of claim 6, wherein the shaft comprises a serration that is configured to contact the set screw.

8. The mount bracket of claim 1, wherein in a state where the at least one fixing portion is separated from the at least one first connecting portion or the at least one second connecting portion, the coupler is configured to rotate together with the shaft.

9. The mount bracket of claim 1, further comprising a shaft locker that is configured to be inserted into the shaft through the coupler,
wherein the at least one fixing portion is configured to be connected to the at least one first connecting portion or the at least one second connecting portion, and
wherein the shaft locker is configured to be connected to the coupler and prevent the rotation of the shaft.

10. The mount bracket of claim 1, wherein the at least one first connecting portion comprises two first connecting portions, the two first connecting portions being spaced apart from each other and configured to be respectively connected to an upper portion of the shaft and a lower portion of the shaft in an axial direction of the shaft,
wherein the at least one second connecting portion comprises two second connecting portions, the two second connecting portions configured to be between the two first connecting portions in the axial direction while the two second connecting portions are connected to the shaft, and
wherein the at least one fixing portion is configured to be mounted on each of the two first connecting portions.

11. The mount bracket of claim 3, wherein the at least one fixing portion comprises a first cap, the first cap configured to be connected to the at least one first connecting portion or the at least one second connecting portion, and
wherein the first cap comprises:
a first inner hole that corresponds to a first shaft hole, the first shaft hole being in an upper end of the shaft;
a first outer hole that corresponds to a first outer fastening hole, the first outer fastening hole being in an end of the at least one first connecting portion or the at least one second connecting portion;
a first inner screw that is configured to be fastened into the first shaft hole through the first inner hole; and
a first outer screw that is configured to be fastened into the first outer fastening hole through the first outer hole.

12. The mount bracket of claim 11, wherein the first outer hole comprises an elongated hole shape that extends in a circumferential direction of the first cap,
wherein, in a state where threads of the first outer screw are not engaged with the first outer fastening hole, the first outer screw is movable along the first outer hole in the circumferential direction, and the first bracket is configured to be rotatable about the shaft.

13. The mount bracket of claim 11, wherein the first outer screw comprises a spring,
wherein a portion of the first outer screw is movable along the first outer hole while being pre-engaged with the first outer fastening hole, and
wherein, in a case where the first outer screw is pressed, the first cap is configured to be fixed to the at least one first connecting portion by threads of the first outer screw being engaged with the first outer fastening hole.

14. The mount bracket of claim 11, wherein the first cap is configured to be mounted on a first connecting portion or a second connecting portion, which is connected to an upper portion of the shaft, among the at least one first connecting portion or the at least one second connecting portion,
wherein the at least one fixing portion further comprises a second cap that is configured to be mounted on a first connecting portion or a second connecting portion, which is connected to a lower portion of the shaft, among the at least one first connecting portion or the at least one second connecting portion, and
wherein the second cap is configured to be screw-coupled to an inner surface of the first connecting portion or the second connecting portion, which is connected to the lower portion of the shaft, and contact a lower end of the shaft.

15. The mount bracket of claim 11, wherein the first cap is configured to be mounted on a first connecting portion or a second connecting portion, which is connected to an upper portion of the shaft, among the at least one first connecting portion or the at least one second connecting portion,
wherein the at least one fixing portion further comprises a second cap that is configured to be mounted on a first connecting portion or a second connecting portion, which is connected to a lower portion of the shaft, among the at least one first connecting portion or the at least one second connecting portion,
wherein the second cap comprises:
a second inner hole that corresponds to a second shaft hole, the second shaft hole being in a lower end of the shaft;
a second outer hole corresponding to an outer fastening hole, the outer fastening hole being in an end of the first connecting portion or the second connecting portion connected to the lower portion of the shaft;
a second inner screw that is configured to be fastened into the second shaft hole through the second inner hole; and
a second outer screw that is configured to be fastened into the outer fastening hole through the second outer hole.

16. The mount bracket of claim 3, wherein the at least one fixing portion comprises a first cap that is configured to be mounted on a first connecting portion or a second connecting portion, which is located at an upper portion of the shaft in the axial direction, among the at least one first connecting portion or the at least one second connecting portion,
wherein the first cap comprises:
an anchor configured to be inserted into the shaft and the first connecting portion or the second connecting portion;
an anchor spring in the anchor;
an outer hole corresponding to an outer fastening hole, the outer fastening hole being in an end of the first connecting portion or the second connecting portion; and
an outer screw configured to be fastened into the outer fastening hole through the outer hole, and
wherein the anchor is configured to, by pressing of the anchor spring, press an end of the shaft in the axial direction.

17. The mount bracket of claim 16, wherein the anchor spring is configured to, in an unpressed state, separate the anchor from an upper end of the shaft.

18. The mount bracket of claim 16, wherein, in a case where the anchor spring is in an unpressed state, the outer screw is configured to be pre-engaged with the outer fastening hole, and
wherein, in a case where the anchor spring is in a pressed state, the anchor contacts an upper end of the shaft and the outer screw is configured to be fastened into the outer fastening hole.

19. The mount bracket of claim 16, wherein the anchor comprises a lower protrusion,
wherein the shaft comprises a stopper on an inner surface of the shaft,
wherein a lower end of the anchor spring is configured to contact an upper surface of the stopper, and
wherein the stopper is configured to restrict a rising height of the lower protrusion.

20. A mount bracket comprising:
a shaft;
a first bracket comprising:
two first connecting portions configured to be connected to an upper portion of the shaft and a lower portion of the shaft in an axial direction of the shaft, respectively; and
a first wing portion extending from the two first connecting portions;
a second bracket comprising:
two second connecting portions configured to be between the two first connecting portions while the two second connecting portions are connected to the shaft; and
a second wing portion extending from the two second connecting portions;
a coupler configured to be between the two second connecting portions, wherein the shaft is configured to be inserted into the coupler and the coupler is configured to mount an external device;
a first cap configured to be mounted on an uppermost first connecting portion among the two first connecting portions, the first cap fixing the shaft to the uppermost first connecting portion; and
a second cap configured to be mounted on a lowermost first connecting portion among the two first connecting portions, the second cap fixing the shaft to the lowermost first connecting portion,
wherein the first bracket and the second bracket are configured to be rotatable about the shaft, such that the first wing portion and the second wing portion are arranged at an angle corresponding to a shape of an installation structure, and
wherein the first cap and the second cap are configured to fix the two first connecting portions to the shaft to prevent rotation of the first bracket and the shaft.
